(19) United States
(12) Patent Application Publication
(10) Pub. No.: US 2025/0014882 A1
(43) Pub. Date: Jan. 9, 2025

(54) AN AUTOMATED SYSTEM FOR PROVIDING AT LEAST ONE SAMPLE FOR ELECTROSPRAY IONIZATION IN A MASS SPECTROMETER SYSTEM

(71) Applicant: Deutsches Krebsforschungszentrum Stiftung des oeffentlichen Rechts, Heidelberg (DE)

(72) Inventors: Mogjiborahman Salek, Heidelberg (DE); Jonas Foerster, Heidelberg (DE); Angelika Beate Riemer, Heidelberg (DE)

(73) Assignee: Deutsches Krebsforschungszentrum Stiftung des oeffentlichen Rechts, Heidelberg (DE)

(21) Appl. No.: 18/713,328

(22) PCT Filed: Dec. 6, 2022
(86) PCT No.: PCT/EP2022/084532

§ 371 Date: May 24, 2024

(30) Foreign Application Priority Data
Dec. 7, 2021 (EP) 21212835.9

(51) Int. Cl. H01J 49/04; H01J 49/16

(52) U.S. Cl. CPC H01J 49/0413; H01J 49/0431; H01J 49/167

(57) ABSTRACT

An automated system (112) for providing at least one sample (136) for electrospray ionization in a mass spectrometer system (110) is disclosed. The automated system (112) comprises: •at least one electrospray emitter (122) comprising at least one emitter end (120) having at least one emitter tip (124) and at least one fluid-entrance end (126); •at least one autosampler (132), wherein the autosampler (132) comprises at least one autosampler outlet (134), wherein the autosampler (132) is configured for providing at least one sample (136) having at least one analyte; •at least one pipe (138) having at least one pipe fluid-outlet end (142) and at least one pipe fluid-inlet end (144), wherein the pipe fluid-inlet end (144) is fluidically connected to the autosampler outlet (134); •at least one liquid junction (146), wherein the liquid junction (146) comprises at least one connecting element (148) being made of at least one electrically conductive material, wherein the connecting element (148) receives the fluid-entrance end (126) of the electrospray emitter (122) and the pipe fluid-outlet end (142) of the pipe (138) such that a fluid connection between the electrospray emitter (122) and the pipe (138) is established, wherein the connecting element (148) is electrically connectable to at least one voltage source; wherein the emitter tip (124) comprises an opening having a diameter of 1 μm to 10 μm.

### TECHNICAL FIELD

The invention relates to an automated system for providing at least one sample for electrospray ionization in a mass spectrometer system, a mass spectrometer system, a method for providing and ionizing at least one sample by electrospray ionization in a mass spectrometer system, a method for optimizing at least one mass spectrometry (MS) parameter, a method for detecting at least one analyte in a sample by mass spectrometry (MS) and to uses of the automated system and/or of the mass spectrometer system. The devices and methods may have broad applications in proteomics, peptidomics and metabolomics research fields. Further, the devices and methods may be applied for analysis of small molecules in metabolomics, drug discovery and may further be useful for analysis of therapeutic antibodies. Other applications, however, are also feasible.

### BACKGROUND ART

Direct detection of tumor-derived neoepitopes, in the context of personalized immunotherapy, commonly poses an analytical challenge as neoepitopes can be of very low abundance. Orbitrap instrumentation coupled to nano-liquid chromatography (nanoLC-MS) and/or ion-mobility type interfaces such as Field Asymmetric Ion Mobility Spectrometry (FAIMS) could principally increase the sensitivity required for rare peptide detection. However, it entails fine-tuning of essential instrument parameters for each individual peptide.

In WO 2013/102670 Al an electrostatic spray ionization method is described. In the electrostatic spray ionization method for spraying a liquid layer from an insulating plate, the plate is arranged between two electrodes. A constant high voltage power supply is provided and an electric circuit is used to charge and discharge locally a surface of the liquid layer on the insulating plate by applying the power supply between the electrodes.

US 2019/0259597 Al describes a liquid junction apparatus for electrospray ionization in a mass spectrometer comprising an electrospray emitter, a capillary conduit assembly for conducting liquid to be electrosprayed, and a union comprising an electrically conductive material, in which the electrospray emitter and the capillary conduit assembly are accommodated in a bottom-sealing butt joint featuring low dead volume while retaining at least one of them pluggable and withdrawable. The liquid junction apparatus facilitates energizing the transmitted liquid to a predetermined voltage level at the liquid junction upstream of an actual emitter tip where electrospraying occurs, while retaining at least one of an electrospray emitter and a capillary conduit assembly pluggable into and withdrawable from a union that comprises a conductive material.

In Giovanni D'Orazio et al., Journal of Chromatography A, 1317 (2013) 67-76, a studying of a new nano-liquid-junction interface for coupling both capillary electrochromatography (CEC) or nanoliquid chromatography (nano-LC) with mass spectrometry (MS) is described. The interface was a small T piece of polymeric material where capillary column and tip capillary were positioned at 180° while the third exit (at 90°) was occupied by a capillary delivering a liquid-assisting spray ionization for CEC experiments or by the electrode for the high voltage spray for nano-LC. Experiments were carried out analyzing mixtures of some organophosphorus pesticides (OPPs) or anti-inflammatory and related acidic drugs with MS detection in positive or negative ion mode, respectively.

U.S. Pat. No. 10,983,098 B2 describes a liquid chromatograph. The liquid chromatograph includes a column, a liquid sending unit configured to send a mobile phase to the column at a pressure higher than atmospheric pressure, a first pipe having one end connected to an outlet of the column, and a second pipe having one end connected to an end face at the other end of the first pipe with a connection gap sandwiched between the one end of the second pipe and end face, the second pipe having the other end disposed in an ionization chamber having a pressure less than or equal to atmospheric pressure.

WO 98/35226 A1 describes a design of a simple and rugged sheathless interface for capillary electrophoresis/electrospray ionization-mass spectrometry (CE/ESI-MS) using common laboratory tools and chemicals. The interface uses a small platinum (Pt) wire which is inserted into the CE capillary through a small hole near the terminus. The position of the wire inside the CE capillary and within the buffer solution is analogous to standard CE separation operations where the terminus of the CE capillary is placed inside a buffer reservoir along with a grounded platinum electrode. By combining the use of the in-capillary electrode interface with sharpening of the fused silica tip of the CE capillary outlet, a stable electrospray current was maintained for an extended period of time.

U.S. Pat. No. 5,993,633 A refers to an interface between a capillary electrophoresis separation capillary end and an electrospray ionization mass spectrometry emitter capillary end, for transporting an analyte sample from a capillary electrophoresis separation capillary to a electrospray ionization mass spectrometry emitter capillary. The interface has: (a) a charge transfer fitting enclosing both of the capillary electrophoresis capillary end and the electrospray ionization mass spectrometry emitter capillary end; (b) a reservoir containing an electrolyte surrounding the charge transfer fitting; and (c) an electrode immersed into the electrolyte, the electrode closing a capillary electrophoresis circuit and providing charge transfer across the charge transfer fitting while avoiding substantial bulk fluid transfer across the charge transfer fitting.

In Kegi Tang et al., J Am Soc Mass Spectrom 2004, 15, 1416-1423, an experimental investigation and theoretical analysis are reported on charge competition in electrospray ionization (ESI) and its effects on the linear dynamic range of ESI mass spectrometric (MS) measurements. The experiments confirmed the expected increase of MS sensitivities as the ESI flow rate decreases. However, different compounds show somewhat different mass spectral peak intensities even at the lowest flow rates, at the same concentration and electrospray operating conditions. MS response for each compound solution shows good linearity at lower concentrations and levels off at high concentration, consistent with analyte “saturation” in the ESI process. The extent of charge competition leading to saturation in the ESI process is consistent with the relative magnitude of excess charge in the electrospray compared to the total number of analyte molecules in the solution.

WO 03/042684 A1 describes a device for connecting a capillary for capillary electrophoresis (CE) to an ionisation source in an apparatus for mass spectrometry (MS). The device comprises a chamber for an electrolyte, which chamber has a first inlet for the capillary and a second inlet for the electrolyte from a reservoir and an outlet for the capillary, where a tubular electrode through which the capillary is passed, is arranged in connection to the outlet, and through which electrode the electrolyte may flow around the capillary, wherein a flow chamber is arranged upstream for the electrode in which flow chamber an electrically conducting surface electrically connected to the electrode is arranged.

Further, Advion offers an in chip-based electrospray ionization technology called TriVersa NanoMate LESA® (Link: https://www.advion.com/products/triversa-nanomate/). Further, on the website of PepSep, emitters are described (link: https://pepsep.com/products.html).

Despite the advantages achieved by the above-mentioned devices and methods, several technical challenges remain. Most of the above-mentioned devices are coupled to chromatographic and electrophoretic separation techniques. Thereby, a complexity of analyte mixtures may be reduced. However, such devices may be limited to specific ranges of physicochemical properties of analytes. The classical static spray workflow may allow direct infusion of microliter amounts of samples for their unbiased analysis, for typical duration of hours, during which time a large number of parameters may be varied and the corresponding data may be recorded. However, it suffers commonly from irreproducibility due to manufacturing of coated glass capillaries which may have a metal coating e.g. by sputter deposition of thin metal layers. The metal coating may be prone to erosion and may introduce irregularities at a tip of the capillary which may lead to electrospray instability. Consequently, in addition to a lack of reproducibility, sample loss, operational tediousness of the manual approach have led to the decline of the use of static spray in mass spectrometry-based proteomics and peptidomics workflows.

### Problem to be Solved

It is therefore desirable to provide an automated system for providing at least one sample for electrospray ionization in a mass spectrometer system, a mass spectrometer system, a method for providing and ionizing at least one sample by electrospray ionization in a mass spectrometer system, a method for optimizing at least one mass spectrometry (MS) parameter, a method for detecting at least one analyte in a sample by mass spectrometry (MS) and to uses of the automated system and/or of the mass spectrometer system which at least partially address the above-mentioned technical challenges. Specifically, a reproducibility and a throughput of measurements shall be increased.

### SUMMARY

This problem is addressed by an automated system for providing at least one sample for electrospray ionization in a mass spectrometer system, a mass spectrometer system, a method for providing and ionizing at least one sample by electrospray ionization in a mass spectrometer system, a method for optimizing at least one mass spectrometry (MS) parameter, a method for detecting at least one analyte in a sample by mass spectrometry (MS) and to uses of the automated system and/or of the mass spectrometer system with the features of the independent claims. Advantageous embodiments which might be realized in an isolated fashion or in any arbitrary combinations are listed in the dependent claims as well as throughout the specification.

As used in the following, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically will be used only once when introducing the respective feature or element. In the following, in most cases, when referring to the respective feature or element, the expressions “at least one” or “one or more” will not be repeated, non-withstanding the fact that the respective feature or element may be present once or more than once.

Further, as used in the following, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such way with other optional or non-optional features of the invention.

In a first aspect of the present invention an automated system for providing, specifically for delivering, at least one sample for electrospray ionization in a mass spectrometer system is disclosed. The automated system comprises at least one electrospray emitter comprising at least one emitter end having at least one emitter tip and at least one fluid-entrance end. Further, the automated system comprises at least one autosampler. The autosampler comprises at least one autosampler outlet. The autosampler is configured for providing at least one sample having at least one analyte. Further, the automated system comprises at least one pipe, specifically at least one fused silica capillary, having at least one pipe fluid-outlet end and at least one pipe fluid-inlet end. The pipe fluid-inlet end is fluidically connected to the autosampler outlet. Further, the automated system comprises at least one liquid junction. The liquid junction comprises at least one connecting element being made of at least one electrically conductive material. The connecting element receives the fluid-entrance end of the electrospray emitter and the pipe fluid-outlet end of the pipe such that a fluid connection between the electrospray emitter and the pipe is established. The connecting element is electrically connectable to at least one voltage source. The emitter tip comprises an opening having a diameter of 1 μm to 10 μm.

The term “system” as used herein is a broad term and is to be given its ordinary and customary meaning to a person of ordinary skill in the art and is not to be limited to a special or customized meaning. The term specifically may refer, without limitation, to a group of at least two elements which may interact with each other in order to fulfill at least one common function. The at least two components may be handled independently or may be coupled, connectable or integratable in order to form a common component.

The term “mass spectrometer system” as used herein is a broad term and is to be given its ordinary and customary meaning to a person of ordinary skill in the art and is not to be limited to a special or customized meaning. The term specifically may refer, without limitation, to an arbitrary group of at least two elements wherein one of the at least two elements is a mass spectrometric analyzer. Another one of the at least two elements may specifically be a device which is configured for providing and/or preparing at least one sample for performing at least one mass spectrometric analysis. Further details may be given below in more detail.

The term “mass spectrometric analyzer” as used herein is a broad term and is to be given its ordinary and customary meaning to a person of ordinary skill in the art and is not to be limited to a special or customized meaning. The term specifically may refer, without limitation, to an arbitrary analytical technique which is configured for measuring a mass-to-charge ratio of ions. The mass spectrometric analyzer may comprise at least one mass analyzer and at least one detector. The mass analyzer and the detector may be arranged in an ionization chamber. The ionization chamber may also be referred to as ion source. The mass analyzer may be configured for sorting and separating ions according to their mass to charge ratio. The mass spectrometric analyzer may comprise several ion optics such as electromagnetic elements like skimmer, focusing lens, multipoles. The ion optics may be configured for transferring ions to a region within the ionization chamber where the mass analyzer is arranged. The mass spectrometric analyzer may be selected from the group consisting of: a time-of-flight analyzer, a triple quadrupole analyzer, an ion trap, an ion cyclotron resonance cell; an orbitrap. However, also other embodiments may be feasible.

The mass spectrometer system may further comprise at least one ion mobility spectrometry device, preferably a high-field asymmetric-waveform ion-mobility spectrometry device. The ion mobility spectrometry device may be configured for separating ions produced in an ion source. The term “ion-mobility spectrometry device” as used herein is a broad term and is to be given its ordinary and customary meaning to a person of ordinary skill in the art and is not to be limited to a special or customized meaning. The term specifically may refer, without limitation, to an arbitrary analytical technique which is configured to separate and identify ionized molecules in a gas phase based on their mobility in a carrier buffer gas. The ion-mobility spectrometry device may be configured for actively correcting a drift from an ion path towards an entrance of the mass spectrometer of some ions by a so called compensation voltage (CV) such that the ions may enter the mass spectrometer. The ions may have some specificity such as a given charge state or a given range of charge states. In that way, by applying the CV, ion clouds of certain charge states may be separated from further ions.

The term “electrospray ionization (ESI)” as used herein is a broad term and is to be given its ordinary and customary meaning to a person of ordinary skill in the art and is not to be limited to a special or customized meaning. The term specifically may refer, without limitation, to an arbitrary process, wherein ions are produced using an electrospray. Thereby, a high voltage may be applied to a liquid. Mass spectrometry using ESI is commonly called electrospray ionization mass spectrometry (ESI-MS) or, less commonly, electrospray mass spectrometry (ES-MS). In electrospray ionization, a sample comprising an analyte solution may be passed through a capillary and an electrical voltage may be applied to the sample.

The automated system may specifically be configured for providing at least one sample for static spray ionization. The term “static spray ionization” as used herein is a broad term and is to be given its ordinary and customary meaning to a person of ordinary skill in the art and is not to be limited to a special or customized meaning. The term specifically may refer, without limitation, to an arbitrary electrospray ionization process with no dynamic that changes the electrospray over time in a systematic fashion. Thus, exemplarily, at 1 min the same ions are expected to be detected as at 10 min. Specifically, the static spray ionization refers to an offline analysis of the sample. The term “offline analysis” may refer to an analysis technique, wherein an infusion of a sample may be performed without any specific separation being applied to the sample prior to its ionization. To the contrary, online analysis may include a usage of a separation chromatographic or electrophoretic device or element.

The term “automated system” as used herein is a broad term and is to be given its ordinary and customary meaning to a person of ordinary skill in the art and is not to be limited to a special or customized meaning. The term specifically may refer, without limitation, to an arbitrary group of at least two elements which may interact with each other in order to fulfill at least one common function wherein at least one of the two elements may be handled at least partially automatically, e.g. which may be able to operate independently of human continual or ceaseless intervention. Specifically the autosampler, more specifically one or more of a valve, a fluid loading device and a pump of the autosampler, and/or the liquid junction, may be configured for being handled automatically, e.g. without user interaction. For this purpose, specifically at least one processing device may be used. The term “processing device” as used herein is a broad term and is to be given its ordinary and customary meaning to a person of ordinary skill in the art and is not to be limited to a special or customized meaning. The term specifically may refer, without limitation, to an arbitrary logic circuitry configured for performing basic operations of a computer or system, and/or, generally, to a device which is configured for performing calculations or logic operations. The processing device may be configured for processing basic instructions that drive the computer or system. As an example, the processing device may comprise at least one arithmetic logic unit (ALU), at least one floating-point unit (FPU), such as a math co-processor or a numeric co-processor, a plurality of registers, specifically registers configured for supplying operands to the ALU and storing results of operations, and a memory, such as an L1 and L2 cache memory. The processing device may be a multi-core processor. The processing device may be or may comprise a central processing unit (CPU). Additionally or alternatively, the processing device may be or may comprise a microprocessor, thus specifically the processor's elements may be contained in one single integrated circuitry (IC) chip. Additionally or alternatively, the processing device may be or may comprise one or more application-specific integrated circuits (ASICs) and/or one or more field-programmable gate arrays (FPGAs) and/or one or more tensor processing unit (TPU) and/or one or more chip, such as a dedicated machine learning optimized chip, or the like. The processing device may be configured, such as by software programming, for performing one or more evaluation operations. As an example, the processing device may comprise a software code stored thereon comprising a number of computer instructions. The processing device may provide one or more hardware elements for performing one or more operations and/or may provide one or more processors with software running thereon.

As outlined above, the automated system is configured for providing at least one sample for electrospray ionization in a mass spectrometer system. Thus, the automated system may also be referred to as sample delivery system. The term “sample delivery system” as used herein is a broad term and is to be given its ordinary and customary meaning to a person of ordinary skill in the art and is not to be limited to a special or customized meaning. The term specifically may refer, without limitation, to an arbitrary system which is configured to deliver a sample for using a sample for a special purpose such as for conducting an analytical measurement. During sample delivery, at least one property of the sample may change. Further details on the components of the automated system may be given below in more detail.

The term “sample” as used herein is a broad term and is to be given its ordinary and customary meaning to a person of ordinary skill in the art and is not to be limited to a special or customized meaning. The term specifically may refer, without limitation, to an arbitrary sample such as a biological sample or a synthetic sample. The sample may comprise one or more analytes of interest. The sample may specifically be a liquid sample, in particular a liquid sample comprising at least one biological material. The sample may be used directly as obtained from the respective source or may be subject of a pretreatment and/or sample preparation workflow. Further, the sample may undergo one or more treatment steps. Thus, at least one property of the sample may change.

The sample may specifically be a biological sample such as a sample comprising proteins, a chemical sample, a synthetic sample, and/or an environmental sample. Further, the sample may be a sample of a subject, preferably a subject suffering or suspected to suffer from a disease, preferably cancer. Further, the sample may be a sample of a cell lysate or a sample of a bodily fluid. Also other embodiments may be feasible.

As outlined above, the sample may comprise the at least one analyte. The term “analyte” as used herein is a broad term and is to be given its ordinary and customary meaning to a person of ordinary skill in the art and is not to be limited to a special or customized meaning. The term specifically may refer, without limitation, to an arbitrary chemical or biological substance or species, such as a molecule or a chemical compound, to be detected and/or measured. Specifically, a presence, an absence, a concentration and/or an amount of the analyte in a sample may be detected or measured.

The analyte may specifically be a biological molecule, preferably a protein. Further, the biological molecule may also be a polypeptide and/or a small molecule metabolite. Specifically, the polypeptide may be an antibody, a peptide presented by a major histocompatibility antigen, or a peptide in the body fluids and/or a metabolite wherein said small molecule metabolite may be a disease marker, or an illicit drug and or its metabolite. Further, the analyte may be a neoepitope presented by a cancer cell. Also other embodiments may be feasible.

The terms “inlet” and “outlet” as used herein are broad terms and are to be given their ordinary and customary meaning to a person of ordinary skill in the art and are not to be limited to a special or customized meaning. The terms specifically may refer, without limitation, to parts of an element through which a fluid medium enters or leaves the element.

The term “being fluidically connected” as used herein is a broad term and is to be given its ordinary and customary meaning to a person of ordinary skill in the art and is not to be limited to a special or customized meaning. The term specifically may refer, without limitation, to a property, wherein two or more elements are connected such that a transfer of an arbitrary fluid medium from one of the two elements to the other one of the two elements or vice versa is provided.

As outlined above, the automated system comprises the electrospray emitter. The term “electrospray emitter” is a broad term and is to be given its ordinary and customary meaning to a person of ordinary skill in the art and is not to be limited to a special or customized meaning. The term specifically may refer, without limitation, to an arbitrary device which is configured for emitting electrospray. The electrospray may comprise charged drops of a sample, specifically fine, highly unipolar charged drops of the sample with a narrow size distribution. The electrospray emitter may specifically comprise at least one fused silica capillary. The term “capillary” generally refers to an arbitrary small, elongate void volume such as a small tube. Generally, the capillary may comprise dimensions in the sub-millimeter range. Commonly, a fluidic medium may migrate through the capillary by capillary action wherein the fluidic medium may flow in narrow spaces of the capillary without an assistance of external forces like gravity due to intermolecular forces between the fluidic medium and a surface of the capillary facing the fluidic medium.

The electrospray emitter may comprise two opposing ends, specifically the fluid entrance end, which may also be referred to as inlet, and the emitter end, which may also be referred to as outlet. As outlined above, the emitter end comprises the emitter tip. The term “tip” as used herein is a broad term and is to be given its ordinary and customary meaning to a person of ordinary skill in the art and is not to be limited to a special or customized meaning. The term specifically may refer, without limitation, to a sharp end of an arbitrary element, specifically of an elongated element. Specifically, the emitter tip may be tapered conically at the emitter end. The emitter tip comprises an opening having a diameter of 1 μm to 10 μm. Specifically, the opening of the emitter tip has a diameter of 2 μm to 6 μm, preferably of 2.5 μm to 5.5 μm, most preferably of 3 μm to 5 μm. The opening of the emitter tip may also be referred to as orifice.

As outlined above, the automated system comprises the autosampler. The term “autosampler” as used herein is a broad term and is to be given its ordinary and customary meaning to a person of ordinary skill in the art and is not to be limited to a special or customized meaning. The term specifically may refer, without limitation, to an arbitrary device which automatically feeds samples to laboratory equipment such as the mass spectrometric analyzer. The autosampler may specifically be configured to provide at least one sample. Thus, specifically, the autosampler may comprise at least one storage element such as a flask or a container configured for providing the liquid and, specifically, for storing the liquid. Specifically, the autosampler may comprise a plurality of the storage elements. Further, additionally or alternatively, the autosampler may comprise at least one connecting line such as at least one tube. The connecting line may be configured for transferring the liquid to a desired place or for transferring the liquid to another element. Thus, the autosampler may also be referred to as liquid supply.

The autosampler may specifically comprise at least one sample tray which is configured for providing the at least one sample. The term “sample tray” as used herein is a broad term and is to be given its ordinary and customary meaning to a person of ordinary skill in the art and is not to be limited to a special or customized meaning. The term specifically may refer, without limitation, to an arbitrary device which is configured for receiving and holding at least one sample specifically at least one liquid sample. Specifically, the sample tray may be or may comprise a holder for a plurality of flasks or containers which are configured for providing the sample and, specifically, for storing the sample. Further, the sample tray may comprise a plurality of the flasks or the containers. Further, the autosampler may comprise at least one needle. The needle may be connected or connectable to a tube which in turn may be connected or connectable to a sample port of a first valve which may further be described below in more detail. The needle may be configured to be electively received in one of the flasks or containers of the sample tray as well as in at least one needle seat of the autosampler.

The needle seat may be configured for receiving the needle. Specifically, the autosampler may be configured for washing the needle when the needle is received in the needle seat as will further be described below in more detail.

Further, the autosampler may specifically comprise at least one first valve having at least one sample loop being configured for receiving the sample. The terms “first valve”, “second valve” and “third valve” may be considered as nomenclature only, without numbering or ranking the named elements, without specifying an order and without excluding a possibility that several kinds of first valves, second valves or third valves may be present. Further, additional blocks, ports or positions such as one or more fourth valves may be present.

The term “valve” as used herein is a broad term and is to be given its ordinary and customary meaning to a person of ordinary skill in the art and is not to be limited to a special or customized meaning. The term specifically may refer, without limitation, to an arbitrary device which is configured for shutting off or controlling a flow of fluids. Specifically, the valve may comprise at least one rotatable element such as a disk comprising one or more channels configured for receiving the fluid. Further, the valve may comprise at least one stationary element have one or more ports and, optionally, further channels configured for channeling/directing the fluid. The channels of the rotatable element may be electively connectable to the ports and, optionally, to the further channels of the stationary element by rotation of the rotatable element.

The term “sample loop” as used herein is a broad term and is to be given its ordinary and customary meaning to a person of ordinary skill in the art and is not to be limited to a special or customized meaning. The term specifically may refer, without limitation, to an arbitrary element which may have an elongate shape and which may provide a free volume or lumen and which enables a flow of a sample there through. Consequently, the sample loop may be configured to receive the sample and/or to provide a transfer of the sample from one end of the sample loop to the other end of the sample loop.

Further, the autosampler may specifically comprise at least one fluid loading device, specifically at least one syringe, wherein the fluid loading device is configured for loading the sample loop of the first valve with the sample provided by the sample tray. The term “fluid loading device” as used herein is a broad term and is to be given its ordinary and customary meaning to a person of ordinary skill in the art and is not to be limited to a special or customized meaning. The term specifically may refer, without limitation, to an arbitrary device which is configured for applying a fluid, specifically a defined or desired amount of the fluid to another object. The fluid loading device may specifically be the syringe. The term “syringe” may generally refer to a reciprocating pump comprising a plunger or a piston which fits tightly within a cylindrical tube or a barrel. The plunger or the piston may be linearly pulled and pushed along an inside of the tube or the barrel, allowing the syringe to take in and expel the fluid through a discharge orifice at an open end of the tube. The open end of the syringe may be fitted to a tubing to direct the flow into and out of the barrel.

Further, the autosampler may comprise at least one third valve. Further, the autosampler may comprise at least one washing solvent container which is configured for providing at least one washing solvent. The third valve may be configured for electively connecting the fluid loading device to the washing solvent container or to the fluid loading device port of the first valve. The third valve may also be referred to as fluid loading device valve or as syringe valve. With regard to the design and construction of the third valve, reference may be made to the description of the first valve and of the second valve. Specifically, the third valve may comprise four ports. However, also other embodiments of the third valve may be feasible.

Further, the autosampler may specifically comprise at least one pump. The pump may be configured for transferring the sample from the sample loop of the first valve to the autosampler outlet and into the electrospray emitter. The pump may specifically be a nano-pump. The terms “transfer” or “transferring” may generally refer to an active transportation of an arbitrary material from one location to another location or vice versa. Thereby, the term “active transportation” generally means that the transportation is supported by external forces and/or actuation means such as pumps or valves used for a directed transportation of the material. Thus, the term “active transportation” may also refer to a defined manipulation of the material.

The first valve may further comprise at least one sample port, at least one fluid loading device port, at least one pump port and at least one outlet port. The sample tray may be fluidically connectable to the sample loop of the first valve via the sample port. The fluid loading device may be fluidically connectable to the sample loop of the first valve via the fluid loading device port. The pump may be fluidically connectable to the sample loop of the first valve via the pump port. The autosampler outlet may be fluidically connectable to the sample loop of the first valve via the outlet port and an inlet port of the second valve. The automated system may be configured for loading the sample loop of the first valve with the sample by establishing a fluidic connection between the fluid loading device port and the sample port via the sample loop. Further, the automated system may be configured for injecting the sample into the pipe by establishing a fluidic connection between the pump port and the outlet port via the sample loop.

Further, the autosampler may comprise at least one second valve. The second valve may be configured for electively fluidically connecting the outlet port of the first valve to the autosampler outlet or to at least one waste container. The waste container may be an arbitrary container configured for receiving and/or storing fluids which are no longer needed for sample preparation and/or measurement purposes. The second valve may be configured to revert the pump outlet to the waste container, as soon as the sample is transferred from the sample loop of the first valve into the pipe fluid-inlet end of the pipe. With regard to the design of the second valve, reference may be made to the description of the first valve above.

As outlined above, the automated system comprises the pipe. The term “pipe” as used herein is a broad term and is to be given its ordinary and customary meaning to a person of ordinary skill in the art and is not to be limited to a special or customized meaning. The term specifically may refer, without limitation, to an arbitrary connecting element which may be configured for supplying the sample from the autosampler to the electrospray emitter via the liquid junction. Thus, the pipe may also be referred to as supply line. The pipe may specifically be or may comprise a fused silica capillary. However, also other embodiments may be feasible. Specifically, the pipe fluid-inlet end of the pipe may be directly fluidically connected to the autosampler outlet. Thus, no separate element may be arranged between the liquid junction and the autosampler. Specifically, no liquid column may be arranged between the liquid junction and the autosampler.

As outlined above, the automated system comprises the liquid junction. The term “liquid junction” as used herein is a broad term and is to be given its ordinary and customary meaning to a person of ordinary skill in the art and is not to be limited to a special or customized meaning. The term specifically may refer, without limitation, to an arbitrary device which is configured for coupling at least two elements for the purpose of transferring a liquid from one of the elements to another one of the elements. Thus, specifically, a fluid outlet of one of the elements may be fluidically connected or connectable to a fluid inlet of to another one of the elements. Further, the liquid junction may be configured for electrically charging at least one component of the sample by applying an electrical voltage. Specifically, the liquid junction may be configured for achieving a stable and robust electrospray ionization.

As outlined above, the liquid junction comprises the at least one connecting element being made of the at least one electrically conductive material. The electrically conductive material may specifically be steel such as stainless steel. However, also other materials may be feasible. The term “connecting element” as used herein is a broad term and is to be given its ordinary and customary meaning to a person of ordinary skill in the art and is not to be limited to a special or customized meaning. The term specifically may refer, without limitation, to an arbitrary device which is configured for establishing a fluid connection between at least two elements. The fluid connection may specifically be established between a fluid outlet of one of the elements and a fluid inlet of another one of the elements. As outlined above, the connecting element receives the fluid-entrance end of the electrospray emitter and the pipe fluid-outlet end of the pipe such that a fluid connection between the electrospray emitter and the pipe is established. The connecting element may specifically comprise at least one hollow cylinder having at least one first end and at least one opposing second end. The fluid-entrance end of the electrospray emitter may be received in the first end and the pipe fluid-outlet end may be received in the second end. The fluid-entrance end of the electrospray emitter and the pipe fluid-outlet end of the pipe may specifically be received in the connecting element such that a nano-gap is formed between the fluid-entrance end and the pipe fluid-outlet end. Thus, the sample may be charged in the nano-gap by applying the electrical voltage to the connecting element. The electrical voltage may specifically be in the range of 800 V to 1300 V, preferably in the range of 1000 V to 1200 V. Specifically, the electrical voltage may be 1100 V. The nano-gap may specifically have a gap of a size such that a perturbation of an incoming flow of the sample, specifically of an incoming nano-flow of the sample, is prevented or reduced at least to a large extent, specifically by inducing e.g. a vortex leasing to a mixing of the sample with an adjacent transport liquid. Specifically, a distance between the fluid-entrance end of the electrospray emitter and the pipe fluid-outlet end and/or the diameter of the gap may be in dimensions in the nanometer regime. The “adjacent transport liquid” refers to a liquid which sandwiches the sample from both sides.

In a further aspect of the present invention, a mass spectrometer system is disclosed. The mass spectrometer system comprises at least one automated system as described above or as will further be described below in more detail. Further, the mass spectrometer system comprises at least one mass spectrometric analyzer having at least one ion source. The emitter end of the electrospray emitter is arranged within the ion source.

In a further aspect of the present invention, a method for providing and ionizing at least one sample by electrospray ionization in a mass spectrometer system is disclosed.

The method comprises using the automated system as described above or as will further be described below in more detail.

The methods comprise the method steps as given in the independent claims and as listed as follows. The method steps may be performed in the given order. However, other orders of the method steps are feasible. Further, one or more of the method steps may be performed in parallel and/or in a timely overlapping fashion. Further, one or more of the method steps may be performed repeatedly. Further, additional method steps may be present which are not listed.

The method comprises the following steps:
a) providing at least one sample in at least one sample tray of the autosampler;
b) transferring the sample from the sample tray to the autosampler outlet, whereby the sample is further transferred into the electrospray emitter via the pipe and the liquid junction; and
c) electrically charging at least one component of the sample by applying an electrical voltage to the connecting element of the liquid junction via the voltage source.

The term “providing”, as used herein, is a broad term and is to be given its ordinary and customary meaning to a person of ordinary skill in the art and is not to be limited to a special or customized meaning. The term specifically may refer, without limitation, to a process of making available one or more needed objects.

The terms “transfer” or “transferring” may generally refer to an active transportation of an arbitrary material from one location to another location or vice versa. Thereby, the term “active transportation” generally means that the transportation is supported by external forces and/or actuation means such as pumps or valves used for a directed transportation of the material. Thus, the term “active transportation” may also refer to a defined manipulation of the material.

The autosampler may specifically comprise at least one first valve having at least one sample loop, at least one fluid loading device and at least one pump. For further details with regard to the first valve, the sample loop, the fluid loading device and the pump, reference is made to the description above.

Step b) may further comprise the following steps:
b1) loading the sample loop of the first valve with the sample via the fluid loading device; and
b2) transferring the sample from the sample loop of the first valve to the autosampler outlet via the pump, whereby the sample is further transferred into the electrospray emitter via the pipe and the liquid junction.

Specifically, the first valve may further comprise at least one sample port, at least one fluid loading device port, at least one pump port and at least one outlet port. In step b1) a fluidic connection between the fluid loading device port and the sample port via the sample loop may be established. In step b2) a fluidic connection between the pump port and the outlet port via the sample loop may be established. In step b2) the pump may be configured for pushing the sample from the sample loop of the first valve. The pump may be connected to a solvent bottle. The pump may be configured for aspiring the sample and for pushing the sample through the first valve.

Further, the autosampler may comprise at least one second valve, wherein, specifically before conducting step b), a first washing step may be performed, wherein, during the first washing step, the second valve may fluidically connect the outlet port of the first valve to the waste container, and a fluidic connection may be formed between the pump port and at least one waste container via the sample loop and the outlet port. For further details with regard to the second valve, reference is made to the description above. The first washing step may also be referred to as a sample loop washing step.

The autosampler may further comprise at least one third valve and at least one washing solvent container which may be configured for providing at least one washing solvent. As outlined above, the third valve may also be referred to as fluid loading device valve or as syringe valve. For further details with regard to the third valve and the washing solvent container, reference is made to the description above. At least one second washing step may be performed, specifically before conducting step b). The second washing step may also be referred to as fluid loading device priming step or as syringe priming step. The second washing step may comprise the following steps:
i. fluidically connecting the fluid loading device to the washing solvent container via the third valve whereby the washing solvent is transferred, specifically aspired, into an interior volume of the fluid loading device, specifically into the syringe; and
ii. fluidically connecting the fluid loading device to a waste container via the third valve whereby the washing solvent is transferred from the interior volume of the fluid loading device into the waste container.

Further, at least one third washing step may be performed, specifically before conducting step b). The third washing step may also be referred to as sample needle washing step. The third washing step may comprise the following steps:
i. fluidically connecting the fluid loading device to the washing solvent container via the third valve whereby the washing solvent is transferred, specifically aspired, into an interior volume of the fluid loading device, specifically into the syringe;
ii. placing a needle of the autosampler into a needle seat; and
   iii. fluidically connecting the fluid loading device to the needle via the third valve whereby the washing solvent is transferred from the interior volume of the fluid loading device into the needle seat via fluid loading device port of the first valve and the sample port of the first valve.

The terms “first washing step”, “second washing step” and “third washing step” may be considered as nomenclature only, without numbering or ranking the named steps, without specifying an order and without excluding a possibility that several kinds of first, second or third washing steps may be performed. Further, additional washing steps such as one or more fourth washing steps may be performed.

A pressure within the electrospray emitter during electrospray ionization may be ambient pressure. The term “ambient pressure” as used herein, is a broad term and is to be given its ordinary and customary meaning to a person of ordinary skill in the art and is not to be limited to a special or customized meaning. The term specifically may refer, without limitation, to a pressure of a surrounding medium such as a gas or a liquid which is in contact with an object. Specifically, the pump may be reverted to the waste container as soon as the sample is transferred from the sample tray to the pipe fluid-inlet end of the pipe. After the sample transfer, the pump may be used for washing the sample loop. Specifically, the pump may be configured to idle as soon as the sample is transferring from the sample tray into the pipe fluid-inlet end of the pipe and, specifically, finally into the electrospray emitter.

Further, the pressure within the electrospray emitter during electrospray ionization may be from 1 bar to 50 bar, preferably from 2 bar to 20 bar and most preferably from 5 bar to 15 bar. To the contrary, in liquid chromatography, pressures from 300 bar to 400 bar may be applied, depending on column dimensions and chromatographic mode.

The method may specifically be a method for providing and ionizing at least two samples by electrospray ionization in a mass spectrometer system and the method may comprise the following steps:
(I) performing steps (a) to (c) for a first sample;
(II) removing the first sample and washing at least the electrospray emitter, the pipe, and the liquid junction;
(III) performing steps (a) to (c) for a second sample;
and, optionally, repeating steps (II) and (III) for any further sample.

After step (II) is conducted one, more or even all of the first washing step, the second washing step and the third washing step may be performed.

The terms “first sample” and “second sample” may be considered as nomenclature only, without numbering or ranking the named elements, without specifying an order and without excluding a possibility that several kinds of first samples or second sample may be present. Further, additional samples such as one or more third samples may be present.

In a further aspect of the present invention, a method for optimizing at least one mass spectrometry (MS) parameter is disclosed.

The term “MS parameter” is understood by the skilled person to relate to any MS parameter known or assumed to have an impact on the result of an analytical MS run on a sample. In an embodiment, said MS parameter may be selected from ionization method, detector type, number of fragmentations, and the like.

The term “optimizing at least one MS parameter” is, in principle, understood by the skilled person. In an embodiment, the term relates to analyzing effects of MS parameters. Further, in an embodiment, the term relates to a proceeding comprising modifying parameters of an analytical MS method such that an analyte of interest can be measured essentially interference-free. Further, in an embodiment, the term relates to studying different features of analytes. Specifically, data may be gathered which, especially in a case of determining collision energy, may suggest various optima depending on a pursued aim of an assay that is to be optimized.

The method for optimizing at least one mass spectrometry (MS) parameter comprises the method steps as given in the independent claims and as listed as follows. The method steps may be performed in the given order. However, other orders of the method steps are feasible. Further, one or more of the method steps may be performed in parallel and/or in a timely overlapping fashion. Further, one or more of the method steps may be performed repeatedly. Further, additional method steps may be present which are not listed.

The method comprises the following steps:
(A) providing and ionizing at least one sample by electrospray ionization, specifically by static electrospray ionization;
(B) recording at least two MS spectra under conditions comprising at least two different values for said at least one MS parameter;
(C) comparing the MS spectra recorded in step (b), and
(D) thereby, based on the comparison in step (C), optimizing said at least one MS parameter.

Before step (B) is performed, the ions may be optionally separated in the gas-phase by Field Asymmetric Ion Mobility Spectrometry (FAIMS). Specifically, a FAIMS device may be mounted between the ion source and an entrance of the mass spectrometric analyzer. In this case, the optimizing of the at least one MS parameter may include optimizing parameters e.g. for a given target peptide/molecule to be optimally transferred into the mass spectrometric analyzer.

In a further aspect of the present invention, a method for detecting at least one analyte in a sample by mass spectrometry (MS) is disclosed.

The method for detecting at least one analyte in a sample by mass spectrometry (MS) comprises the method steps as given in the independent claims and as listed as follows. The method steps may be performed in the given order. However, other orders of the method steps are feasible. Further, one or more of the method steps may be performed in parallel and/or in a timely overlapping fashion. Further, one or more of the method steps may be performed repeatedly. Further, additional method steps may be present which are not listed.

The method comprises the following steps:
(A) providing and ionizing a sample using the automated system as described above or as will further be described below in more detail, preferably by the method for providing and ionizing at least one sample by electrospray ionization in a mass spectrometer system as described above or as will further be described below in more detail; and
(B) recording at least one MS spectrum of the ionized sample of step (A).

Further, the method may comprise the following step:
(C) comparing the at least one MS spectrum of step (B) to a reference, thereby detecting at least one analyte.

The term “reference” is, in principle, understood by the skilled person. In an embodiment, the term relates to a reference MS spectrum. Further, in an embodiment, the term relates to an expected value which may be calculated or experimentally determined. Also other embodiments may be feasible. Specifically, the at least one MS spectrum of step (B) may be compared to an extracted spectrum signal which is characteristic for the analyte. The spectrum signal may be computationally determined. Thus, a detection of the analyte may be verified.

In a further aspect of the present invention, a use of the automated system as described above or as will further be described below in more detail, and/or of the mass spectrometer system as described above or as will further be described below in more detail, for optimizing at least one MS parameter, preferably according to the method for optimizing at least one mass spectrometry (MS) parameter as described above or as will further be described below in more detail is disclosed.

In a further aspect of the present invention, a use of the automated system as described above or as will further be described below in more detail, and/or of the mass spectrometer system as described above or as will further be described below in more detail for detecting at least one analyte in a sample, preferably according to the method for detecting at least one analyte in a sample by mass spectrometry (MS) parameter as described above or as will further be described below in more detail is disclosed.

The invention further discloses and proposes a computer program including computer-executable instructions for performing the method according to the present invention in one or more of the embodiments enclosed herein when the program is executed on a computer or computer network. Specifically, the computer program may be stored on a computer-readable data carrier. Thus, specifically, one, more than one or even all of method steps a), b) and c) of the method for providing and ionizing at least one sample, the method steps (A), (B), (C) and (D) of the method for optimizing at least one mass spectrometry (MS) parameter and/or one or even all of method steps (A), (B) and (C) of the method for detecting at least one analyte in a sample by mass spectrometry (MS) as indicated above may be performed by using a computer or a computer network, preferably by using a computer program. Specifically, tables of scan parameters may be provided to an instrument software.

The invention further discloses and proposes a computer program product having program code means, in order to perform more than one or even all of method steps a), b) and c) of the method for providing and ionizing at least one sample, the method steps (A), (B), (C) and (D) of the method for optimizing at least one mass spectrometry (MS) parameter and/or one or even all of method steps (A), (B) and (C) of the method for detecting at least one analyte in a sample by mass spectrometry (MS) as indicated above according to the present invention in one or more of the embodiments enclosed herein when the program is executed on a computer or computer network. Specifically, the program code means may be stored on a computer-readable data carrier.

Further, the invention discloses and proposes a data carrier having a data structure stored thereon, which, after loading into a computer or computer network, such as into a working memory or main memory of the computer or computer network, may execute more than one or even all of method steps a), b) and c) of the method for providing and ionizing at least one sample, the method steps (A), (B), (C) and (D) of the method for optimizing at least one mass spectrometry (MS) parameter and/or one or even all of method steps (A) and (B) of the method for detecting at least one analyte in a sample by mass spectrometry (MS) as indicated above according to one or more of the embodiments disclosed herein.

The invention further proposes and discloses a computer program product with program code means stored on a machine-readable carrier, in order to perform more than one or even all of method steps a), b) and c) of the method for providing and ionizing at least one sample, the method steps (A), (B), (C) and (D) of the method for optimizing at least one mass spectrometry (MS) parameter and/or one or even all of method steps (A) and (B) of the method for detecting at least one analyte in a sample by mass spectrometry (MS) as indicated above according to one or more of the embodiments disclosed herein, when the program is executed on a computer or computer network. As used herein, a computer program product refers to the program as a tradable product. The product may generally exist in an arbitrary format, such as in a paper format, or on a computer-readable data carrier. Specifically, the computer program product may be distributed over a data network.

Finally, the invention proposes and discloses a modulated data signal which contains instructions readable by a computer system or computer network, for performing more than one or even all of method steps a), b) and c) of the method for providing and ionizing at least one sample, the method steps (A), (B), (C) and (D) of the method for optimizing at least one mass spectrometry (MS) parameter and/or one or even all of method steps (A) and (B) of the method for detecting at least one analyte in a sample by mass spectrometry (MS) as indicated above according to one or more of the embodiments disclosed herein.

Preferably, referring to the computer-implemented aspects of the invention, more than one or even all of method steps a), b) and c) of the method for providing and ionizing at least one sample, the method steps (A), (B), (C) and (D) of the method for optimizing at least one mass spectrometry (MS) parameter and/or one or even all of method steps (A) and (B) of the method for detecting at least one analyte in a sample by mass spectrometry (MS) as indicated above according to one or more of the embodiments disclosed herein may be performed by using a computer or computer network. Thus, generally, any of the method steps including provision and/or manipulation of data may be performed by using a computer or computer network. Generally, these method steps may include any of the method steps, typically except for method steps requiring manual work, such as providing the samples and/or certain aspects of performing the actual measurements.

Specifically, the present invention further discloses:
A computer or computer network comprising at least one processor, wherein the processor is adapted to perform more than one or even all of method steps a), b) and c) of the method for providing and ionizing at least one sample, the method steps (A), (B), (C) and (D) of the method for optimizing at least one mass spectrometry (MS) parameter and/or one or even all of method steps (A) and (B) of the method for detecting at least one analyte in a sample by mass spectrometry (MS) according to one of the embodiments described in this description,
a computer loadable data structure that is adapted to perform more than one or even all of method steps a), b) and c) of the method for providing and ionizing at least one sample, the method steps (A), (B), (C) and (D) of the method for optimizing at least one mass spectrometry (MS) parameter and/or one or even all of method steps (A) and (B) of the method for detecting at least one analyte in a sample by mass spectrometry (MS) according to one of the embodiments described in this description while the data structure is being executed on a computer,
a computer program, wherein the computer program is adapted to perform more than one or even all of method steps a), b) and c) of the method for providing and ionizing at least one sample, the method steps (A), (B), (C) and (D) of the method for optimizing at least one mass spectrometry (MS) parameter and/or one or even all of method steps (A) and (B) of the method for detecting at least one analyte in a sample by mass spectrometry (MS) according to one of the embodiments described in this description while the program is being executed on a computer,
a computer program comprising program means for performing more than one or even all of method steps a), b) and c) of the method for providing and ionizing at least one sample, the method steps (A), (B), (C) and (D) of the method for optimizing at least one mass spectrometry (MS) parameter and/or one or even all of method steps (A) and (B) of the method for detecting at least one analyte in a sample by mass spectrometry (MS) according to one of the embodiments described in this description while the computer program is being executed on a computer or on a computer network,
a computer program comprising program means according to the preceding embodiment, wherein the program means are stored on a storage medium readable to a computer,
a storage medium, wherein a data structure is stored on the storage medium and wherein the data structure is adapted to perform more than one or even all of method steps a), b) and c) of the method for providing and ionizing at least one sample, the method steps (A), (B), (C) and (D) of the method for optimizing at least one mass spectrometry (MS) parameter and/or one or even all of method steps (A) and (B) of the method for detecting at least one analyte in a sample by mass spectrometry (MS) according to one of the embodiments described in this description after having been loaded into a main and/or working storage of a computer or of a computer network, and
a computer program product having program code means, wherein the program code means can be stored or are stored on a storage medium, for performing more than one or even all of method steps a), b) and c) of the method for providing and ionizing at least one sample, the method steps (A), (B), (C) and (D) of the method for optimizing at least one mass spectrometry (MS) parameter and/or one or even all of method steps (A) and (B) of the method for detecting at least one analyte in a sample by mass spectrometry (MS) according to one of the embodiments described in this description, if the program code means are executed on a computer or on a computer network.

The terms “second automated system”, “second mass spectrometer system”, “third mass spectrometer system”, “second method for detecting at least one analyte in a sample by mass spectrometry (MS)” and “third method for detecting at least one analyte in a sample by mass spectrometry (MS)” may be considered as nomenclature only, without numbering or ranking the named elements, without specifying an order and without excluding a possibility that several kinds of first/second/third automated systems, mass spectrometer systems and methods for detecting at least one analyte in a sample by mass spectrometry (MS) may be present.

In a further aspect, a second automated system for providing at least one sample for electrospray ionization in a mass spectrometer system is described. The second automated system comprises at least one electrospray emitter comprising at least one emitter end having at least one emitter tip and at least one fluid-entrance end. Further, the second automated system comprises at least one autosampler. The autosampler comprises at least one autosampler outlet. The autosampler is configured for providing at least one sample having at least one analyte. Further, the second automated system comprises at least one pipe, specifically at least one fused silica capillary, having at least one pipe fluid-outlet end and at least one pipe fluid-inlet end. The pipe fluid-inlet end is fluidically connected to the autosampler outlet. The pipe fluid-outlet end is fluidically connected to the fluid-entrance end of the electrospray emitter. Further, the second automated system comprises at least one device for applying electrical voltage to the sample. The emitter tip comprises an opening having a diameter of 1 μm to 10 μm.

With regard to the electrospray emitter, the pipe and the autosampler, reference to the description above is made.

The device for applying electrical voltage to the sample may be a metal coated emitter. However, also other embodiments may be feasible.

In a further aspect, a second mass spectrometer system is described. The second mass spectrometer system comprises at least one second automated system as described above or as will further be described below in more detail. Further, the second mass spectrometer system comprises at least one mass spectrometric analyzer having at least one ion source. The emitter end of the electrospray emitter is arranged within the ion source.

In a further aspect, a second method for providing and ionizing at least one sample by electrospray ionization in a mass spectrometer system is described. The method comprises using the second automated system as described above or as will further be described below in more detail. The method comprises the following steps:
a) providing at least one sample in at least one sample tray of the autosampler;
b) transferring the sample from the sample tray to the autosampler outlet, whereby the sample is further transferred into the electrospray emitter via the pipe and the liquid junction; and
c) electrically charging at least one component of the sample by applying an electrical voltage to the sample.

In a further aspect, a second method for detecting at least one analyte in a sample by mass spectrometry (MS) is described. The method comprises the following steps:
(A) providing and ionizing a sample using the second automated system as described above or as will further be described below in more detail, preferably by the method for optimizing at least one mass spectrometry (MS) parameter as described above or as will further be described below in more detail; and
(B) recording at least one MS spectrum of the ionized sample of step (A).

In a further aspect, a use of the second automated system as described above or as will further be described below in more detail, and/or of the second mass spectrometer system as described above or as will further be described below in more detail, for optimizing at least one MS parameter, preferably according to the method for optimizing at least one mass spectrometry (MS) parameter as described above or as will further be described below in more detail is disclosed.

In a further aspect, a use of the second automated system as described above or as will further be described below in more detail, and/or of the second mass spectrometer system as described above or as will further be described below in more detail for detecting at least one analyte in a sample, preferably according to the second method for detecting at least one analyte in a sample by mass spectrometry (MS) parameter as described above or as will further be described below in more detail is disclosed.

In a further aspect, a system for providing, specifically for delivering, at least one sample for electrospray ionization in a mass spectrometer system is disclosed. The system comprises at least one electrospray emitter comprising at least one emitter end having at least one emitter tip and at least one fluid-entrance end. Further, the system comprises at least one autosampler. The autosampler comprises at least one autosampler outlet. The autosampler is configured for providing at least one sample having at least one analyte. Further, the system comprises at least one pipe, specifically at least one fused silica capillary, having at least one pipe fluid-outlet end and at least one pipe fluid-inlet end. The pipe fluid-inlet end is fluidically connected to the autosampler outlet. Further, the system comprises at least one liquid junction. The liquid junction comprises at least one connecting element being made of at least one electrically conductive material. The connecting element receives the fluid-entrance end of the electrospray emitter and the pipe fluid-outlet end of the pipe such that a fluid connection between the electrospray emitter and the pipe is established. The connecting element is electrically connectable to at least one voltage source. The emitter tip comprises an opening having a diameter of 1 μm to 10 μm.

With regard to the electrospray emitter, the pipe and the autosampler, reference to the description above is made. Specifically, reference to the description above with regard to the automated system according to the first aspect of the present invention is made.

In a further aspect, a third mass spectrometer system is described. The third mass spectrometer system comprises at least one system as described above or as will further be described below in more detail. Further, the mass spectrometer system comprises at least one mass spectrometric analyzer having at least one ion source. The emitter end of the electrospray emitter is arranged within the ion source.

In a further aspect, a third method for providing and ionizing at least one sample by electrospray ionization in a third mass spectrometer system is described. The method comprises using the system as described above or as will further be described below in more detail. The method comprises the following steps:
a) providing at least one sample in at least one sample tray of the autosampler;
b) transferring the sample from the sample tray to the autosampler outlet, whereby the sample is further transferred into the electrospray emitter via the pipe and the liquid junction; and
c) electrically charging at least one component of the sample by applying an electrical voltage to the sample.

In a further aspect, a third method for detecting at least one analyte in a sample by mass spectrometry (MS) is described. The method comprises the following steps:
(A) providing and ionizing a sample using the system as described above or as will further be described below in more detail, preferably by the third method for optimizing at least one mass spectrometry (MS) parameter as described above or as will further be described below in more detail; and
(B) recording at least one MS spectrum of the ionized sample of step (A).

In a further aspect, a use of the system as described above or as will further be described below in more detail, and/or of the third mass spectrometer system as described above or as will further be described below in more detail, for optimizing at least one MS parameter, preferably according to the method for optimizing at least one mass spectrometry (MS) parameter as described above or as will further be described below in more detail is disclosed.

In a further aspect, a use of the system as described above or as will further be described below in more detail, and/or of the third mass spectrometer system as described above or as will further be described below in more detail for detecting at least one analyte in a sample, preferably according to the third method for detecting at least one analyte in a sample by mass spectrometry (MS) parameter as described above or as will further be described below in more detail is disclosed.

The methods and devices according to the present invention provide a large number of advantages over known methods and devices.

The automated system may be easily plugged in and off the ion source of the mass spectrometric analyzer. The automated system may be configured for delivering the at least one sample, specifically with a low nanoliter per minute flow rate. The automated system may allow a stable ionization when performing the method for providing and ionizing at least one sample by electrospray ionization in a mass spectrometer system.

Aiming at reaching ultrahigh sensitivity, an efficient procedure for optimizing various detection parameters using static spray instead of the common LC-MS methodology may be implemented which may specifically be automated. A large number of LC-MS runs, subsequent cleaning, including multiple back-and-fourth stages wending through multiple software platforms may be avoided.

The automated system according to the present invention may be based on a liquid junction between the tube, specifically the fused silica capillary, and the electrospray emitter, with a controlled size of the tip opening which may also be referred to as orifice. This setup may allow (i) achieving a much more stable electrospray and (ii) opening a perspective of automation for transferring the sample to the electrospray emitter. Static-spray mass spectrometry based on a liquid junction has never been combined to an autosampler before.

A clear advantage of the automated system according to the present invention may lie in achieving an extremely low flow rate. While TriVersa Nano Mate® reaches only 200 nl/min (comparable to nano-LC but without the obvious benefit of the chromatographic separation), the automated system according to the present invention may be capable of achieving ˜10 nl/min. Low electrospray flow may be expected to increase an ionization efficiency up to 100%. A lower flow rate may be expected to provide a wider linear dynamic range, important for the analysis of complex mixture—complex by the number of analytes and their range of concentrations, competing for ionization.

The automated system according to the present invention may have broad applications in proteomics, peptidomics and metabolomics research fields. Specifically the automated system according to the present invention may be configured for taking neoepitope discovery from the current extremely slow and low throughput to higher throughput, capable for instance of rapidly testing libraries of neoepitopes predicted for wide range of tumors. Thus it could help to accelerate rational bed-to-bench-and-back-to-bed type immunotherapeutic design. Beyond neoepitopes, the automated system according to the present invention may be applicable for the analysis of small molecules in metabolomics, drug discovery and will certainly prove useful for the analysis of therapeutic antibodies by intact protein mass spectrometry.

### SHORT DESCRIPTION OF THE FIGURES

Further optional features and embodiments will be disclosed in more detail in the subsequent description of embodiments, preferably in conjunction with the dependent claims. Therein, the respective optional features may be realized in an isolated fashion as well as in any arbitrary feasible combination, as the skilled person will realize. The scope of the invention is not restricted by the preferred embodiments. The embodiments are schematically depicted in the Figures. Therein, identical reference numbers in these Figures refer to identical or functionally comparable elements.

In the Figures:

FIGS. 1A to 1G show an exemplary embodiment of a method for providing and ionizing at least one sample by electrospray ionization in a mass spectrometer system according to the present invention;

FIGS. 2A to 2E show various embodiments of data analysis and visualization;

FIGS. 3A and 3B show a stability of a spray current in different static spray settings (FIG. 3A) and the corresponding quality of MS data (FIG. 3B);

FIG. 4 shows optimization of the normalized collision energy NCE, and

FIG. 5 shows cell plots showing effects of Field Asymmetric Ion Mobility Spectrometry (FAIMS) parameter optimization on the sensitivity of peptide detection.

### DETAILED DESCRIPTION OF THE EMBODIMENTS

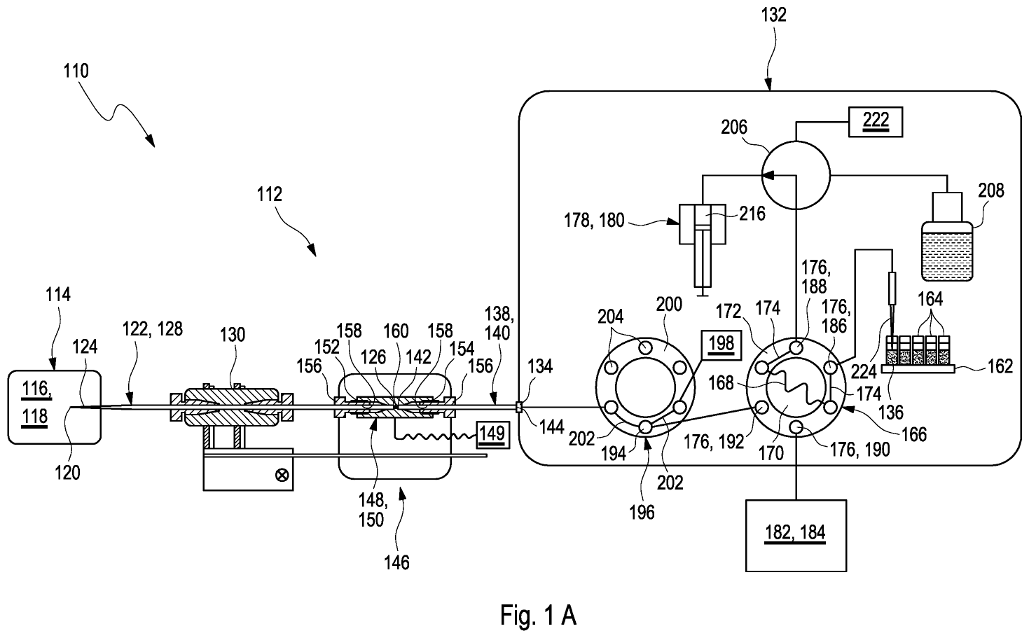

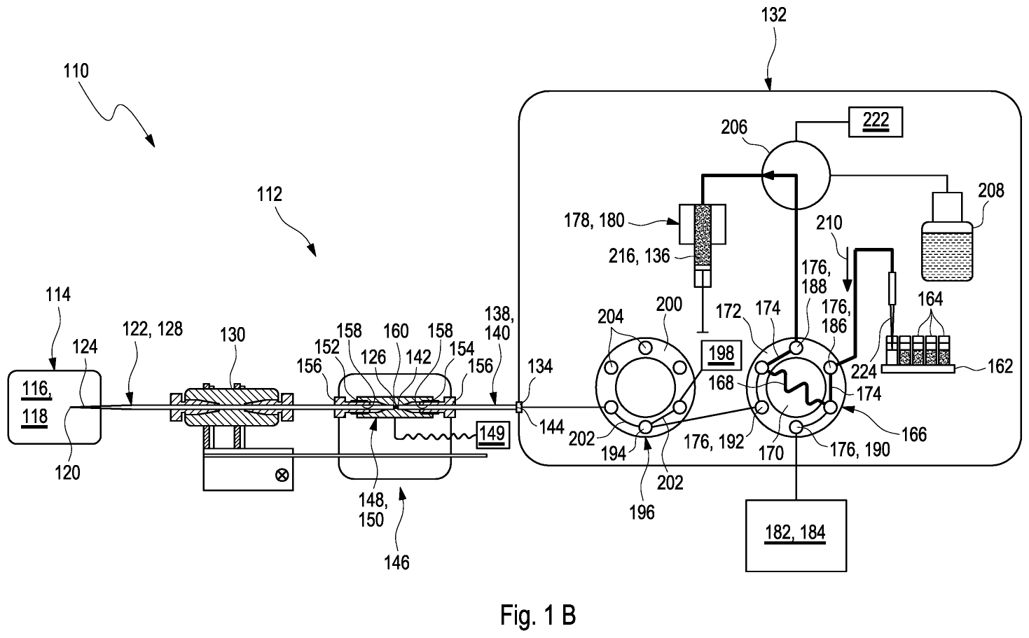

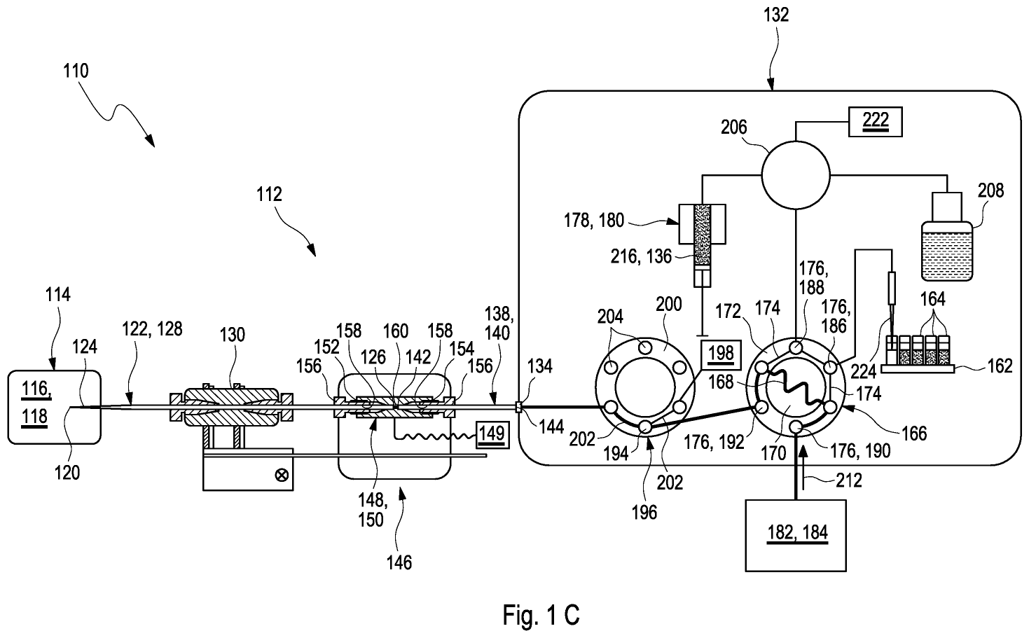

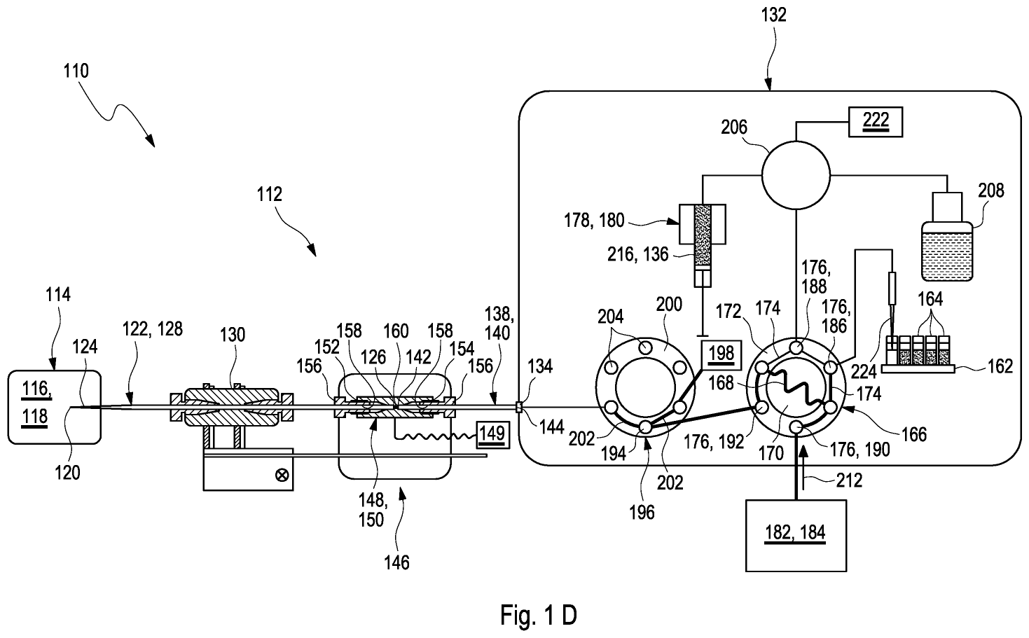

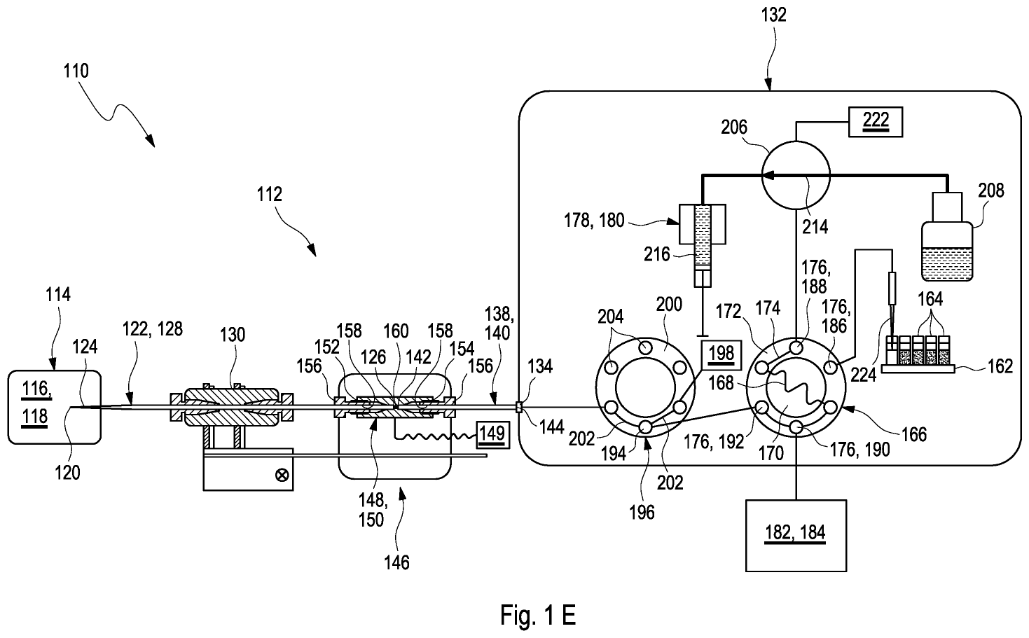

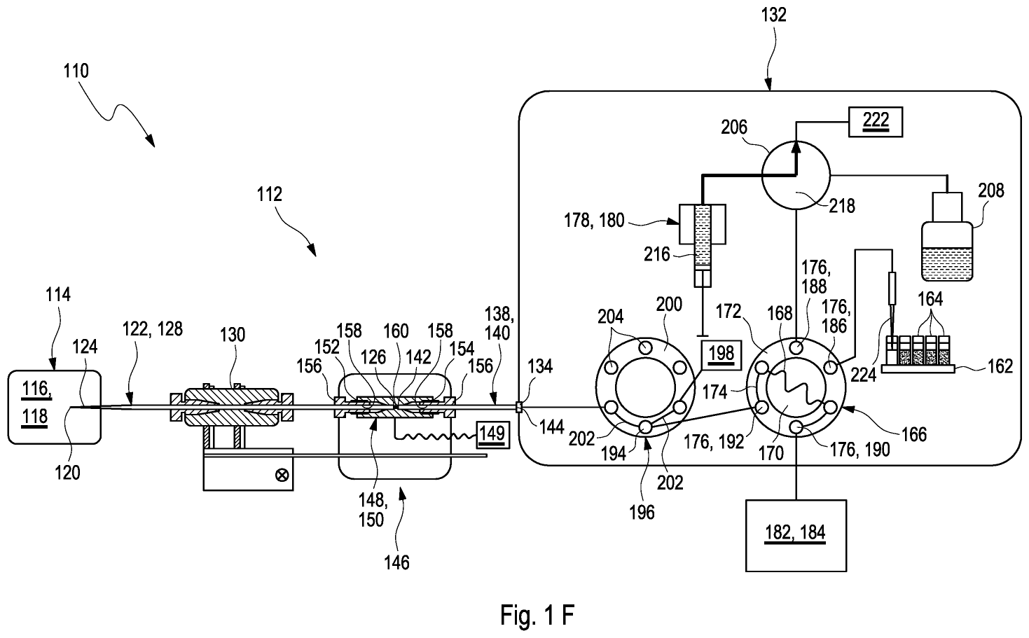

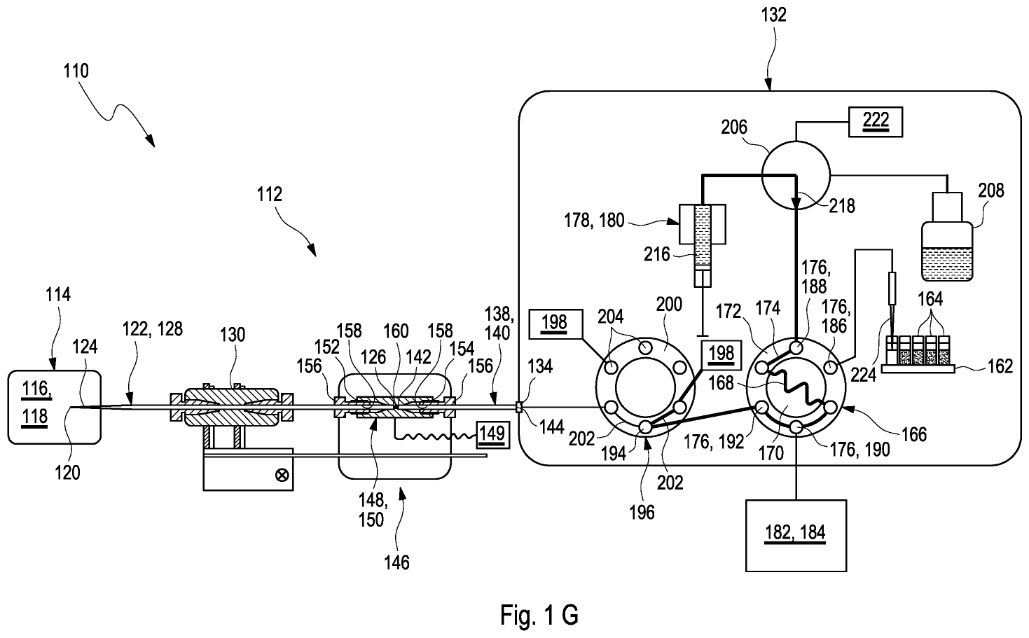

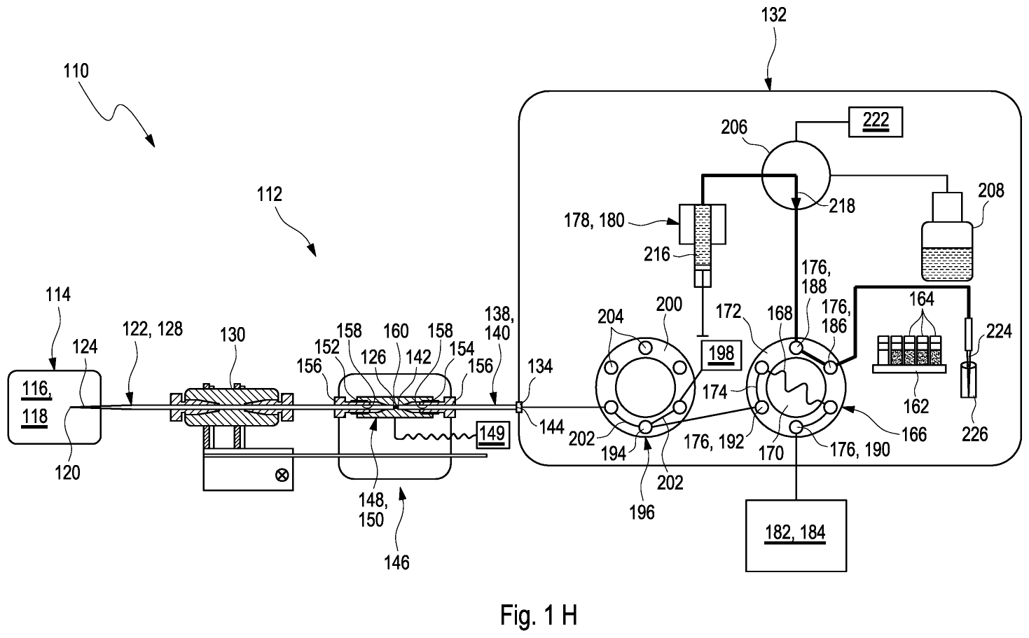

FIGS. 1A to 1F show an exemplary embodiment of a method for providing and ionizing at least one sample by electrospray ionization in a mass spectrometer system 110 according to the present invention in a schematic view.

In FIG. 1A, an exemplary embodiment of the mass spectrometer system 110 is shown. The mass spectrometer system 110 comprises at least one automated system 112 and at least one mass spectrometric analyzer 114. The mass spectrometric analyzer 114 has at least one ion source 116, specifically at least one ionization chamber 118. An emitter end 120 of an electrospray emitter 122 of the automated system 112 is arranged within the ion source 116.

The automated system 112 comprises the at least one electrospray emitter 122 comprising the at least one emitter end 120 having at least one emitter tip and at least one fluid-entrance end 126. The electrospray emitter 122 may specifically comprise at least one fused silica capillary 128. Specifically, the emitter tip 124 may be tapered conically at the emitter end 120. The emitter tip 124 comprises an opening having a diameter of 1 μm to 10 μm. Specifically, the opening of the emitter tip 124 has a diameter of 3 μm or of 5 μm. The electrospray emitter 122 may specifically be a CoAnn emitter provided by CoAnn Technologies. The electrospray emitter 122 may specifically be held by a holder 130. The holder 130 may specifically be a very high pressure, zero-dead-volume (ZDV) union, specifically a ZDV union provided by IDEX Health & Science LLC.

Further, the automated system 112 comprises at least one autosampler 132. The autosampler 132 comprises at least one autosampler outlet 134. The autosampler is configured for providing at least one sample 136 having at least one analyte.

Further, the automated system 112 comprises at least one pipe 138, specifically at least one fused silica capillary 140, having at least one pipe fluid-outlet end 142 and at least one pipe fluid-inlet end 144. The pipe fluid-inlet end 142 is fluidically connected to the autosampler outlet 134.

Further, the automated system 112 comprises at least one liquid junction 146. The liquid junction 146 comprises at least one connecting element 148 being made of at least one electrically conductive material. The connecting element 148 receives the fluid-entrance end 126 of the electrospray emitter 122 and the pipe fluid-outlet end 142 of the pipe 138 such that a fluid connection between the electrospray emitter 122 and the pipe 138 is established. The connecting element 148 is electrically connectable to at least one voltage source 149. The connecting element 148 may specifically comprise at least one hollow cylinder 150 having at least one first end 152 and at least one opposing second end 154. The fluid-entrance end 126 of the electrospray emitter 122 may be received in the first end 152 and the pipe fluid-outlet end 142 may be received in the second end 154. The first end 152 and the second end 154 may respectively be sealed with screws 156. The screws 156 may respectively have through holes 158 for receiving the electrospray emitter 122 and the pipe 138, respectively. The fluid-entrance end 126 of the electrospray emitter 122 and the pipe fluid-outlet end 142 of the connecting element 148 may specifically be received in the connecting element 148 such that a nano-gap 160 is formed between the pipe fluid-outlet end 142 and the fluid-entrance end 126 of the electrospray emitter 122. Thus, the sample 136 may be charged by or in the nano-gap 160 by applying the electrical voltage to the connecting element 148 via the voltage source 149.

The autosampler 132 may specifically comprise at least one sample tray 162 which is configured for providing the at least one sample 136. The sample tray 162 may have a plurality of flasks 164 which are respectively configured for providing the sample 136 and, specifically, for storing the sample 136.

Further, the autosampler 132 may specifically comprise at least one first valve 166 having at least one sample loop 168 being configured for receiving the sample 136. Specifically, the first valve 166 may comprise at least one stationary element 170 comprising the sample loop 168 configured for receiving the sample 136. Further, the first valve 166 may comprise at least one rotatable element 172 having channels 174 configured for channeling/directing the sample 136. Each port 176 may be connected to a neighboring port 176, specifically at immediate right and left sides via one of the channels 174.

Further, the autosampler 132 may specifically comprise at least one fluid loading device 178, specifically at least one syringe 180, wherein the fluid loading device 178 is configured for loading the sample loop 168 of the first valve 166 with the sample 136 provided by the sample tray 162. Further, the autosampler 132 may specifically comprise at least one pump 182, specifically at least one nano-pump 184. The pump 182 may be configured for transferring the sample 136 from the sample loop 168 of the first valve 166 to the autosampler outlet 134 and into the electrospray emitter 122.

The first valve 166 may comprise at least one sample port 186, at least one fluid loading device port 188, at least one pump port 190 and at least one outlet port 192. The sample tray 162 may be fluidically connectable to the sample loop 168 of the first valve 166 via the sample port 186. The fluid loading device 178 may be fluidically connectable to the sample loop 168 of the first valve 166 via the fluid loading device port 188. The pump 182 may be fluidically connectable to the sample loop 168 of the first valve 166 via the pump port 190. The autosampler outlet 134 may be fluidically connectable to the sample loop 168 of the first valve 166 via the outlet port 192 and an inlet port 194 of a second valve 196 which may further be described below in more detail. The automated system 112 may be configured for loading the sample loop 168 of the first valve 166 with the sample 136 by establishing a fluidic connection between the fluid loading device port 188 and the sample port 186 via the sample loop 168. Further, the automated system 112 may be configured for injecting the sample 136 into the pipe 138 by establishing a fluidic connection between the pump port 190 and the outlet port 192 via the sample loop 168.

Further, the autosampler 132 may comprise the at least one second valve 196. The second valve 196 may be configured for electively fluidically connecting the outlet port 192 of the first valve 166 to the autosampler outlet 134 or to at least one waste container 198. The second valve 196 may be configured to revert the pump port 190 to the waste container 198, as soon as the sample 136 is transferred from the sample loop 168 of the first valve 166 into the pipe fluid-inlet end 144 of the pipe 138. The second valve 196 may have a rotatable element 200 having channels 202 configured for channeling the sample 136. Each port 204 may be connected to a neighboring port 204, specifically at immediate right and left sides via one of the channels 202.

Further, the autosampler 132 may comprise at least one third valve 206. Further, the autosampler 132 may comprise at least one washing solvent container 208 which is configured for providing at least one washing solvent. The third valve 206 may be configured for electively connecting the fluid loading device 178 to the washing solvent container 208 or to the fluid loading device port 188 of the first valve 166.

As illustrated in FIG. 1A, in a first step of the method for providing and ionizing at least one sample 136 by electrospray ionization in a mass spectrometer system 110 the at least one sample 136 is provided in the at least one sample tray 162, specifically in the at least one flask 164, of the autosampler 132.

As illustrated in FIGS. 1B and 1C, in a second step of the method for providing and ionizing at least one sample 136 by electrospray ionization in a mass spectrometer system 110 the sample 136 is transferred from the sample tray 162 to the autosampler outlet 134, whereby the sample 136 is further transferred into the electrospray emitter 122 via the pipe 138 and the liquid junction 146.

Specifically, as illustrated in FIG. 1B, the sample loop 168 of the first valve 166 may be loaded with the sample 136 via the fluid loading device 178 as illustrated with arrow 210. Specifically, a fluidic connection between the fluid loading device port 188 and the sample port 186 via the sample loop 168 may be established.

Specifically, as illustrated in FIG. 1C, thereafter, the sample 136 may be transferred from the sample loop 168 of the first valve 166 to the autosampler outlet 134. The pump 182 may be configured for pushing the sample once the first valve 166 switches from the configuration depicted in FIG. 1B wherein the sample loop 168 is connected to the ports 188 to 186 to the configuration depicted in FIG. 1C wherein the sample loop 168 is connected to the ports 190 to 192. Thereby, the sample 136 may be further transferred into the electrospray emitter 122 via the pipe 138 and the liquid junction 146 as illustrated with arrow 212. Specifically, a fluidic connection between the pump port 190 and the outlet port 192 via the sample loop 168 may be established.

Further, different kinds of washing steps may be performed such as illustrated in FIGS. 1D to 1H.

As illustrated in FIG. 1D, a first washing step is illustrated. The first washing step may also be referred to as sample loop washing step. During the first washing step, the second valve 196 may fluidically connect the outlet port 192 of the first valve 166 to the waste container 198, and a fluidic connection may be formed between the pump port 190 and the waste container 198 via the sample loop 168 and the outlet port 192.

In FIGS. 1E and 1F, a second washing step is illustrated. The second washing step may also be referred to as fluid loading device priming step or as syringe priming step. As illustrated in FIG. 1E, the fluid loading device 178 may fluidically be connected to the washing solvent container 208 via the third valve 206 as indicated with arrow 214 whereby the washing solvent is transferred into an interior volume 216 of the fluid loading device 178. Further, as illustrated in FIG. 1F, the fluid loading device 178 may be fluidically connected to a waste container 222 via the third valve 206 whereby the washing solvent is transferred from the interior volume 216 of the fluid loading device 178 into the waste container 222.

In FIG. 1G, a third washing step is illustrated. The third washing step may also be referred to as sample needle washing step. After the fluid loading device 178 may fluidically be connected to the washing solvent container 208 via the third valve 206 whereby the washing solvent is transferred into an interior volume 216 of the fluid loading device 178 such as illustrated in FIG. 1E, a needle 224 of the autosampler 132 may be placed into a needle seat 226 such as illustrated in FIG. 1G. As further illustrated in FIG. 1G, the fluid loading device 178 may be fluidically connected to the needle 224 via the third valve 206 whereby the washing solvent is transferred from the interior volume 216 of the fluid loading device 178 into the needle seat 226 via fluid loading device port 188 of the first valve 166 and the sample port 186 of the first valve 166.

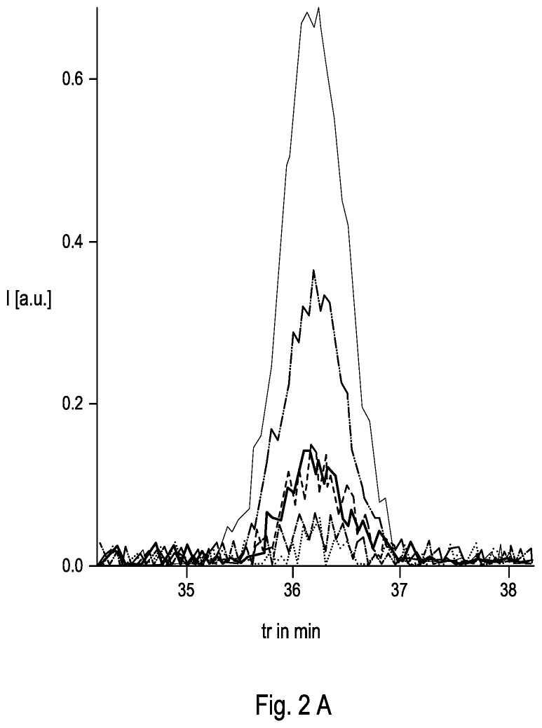

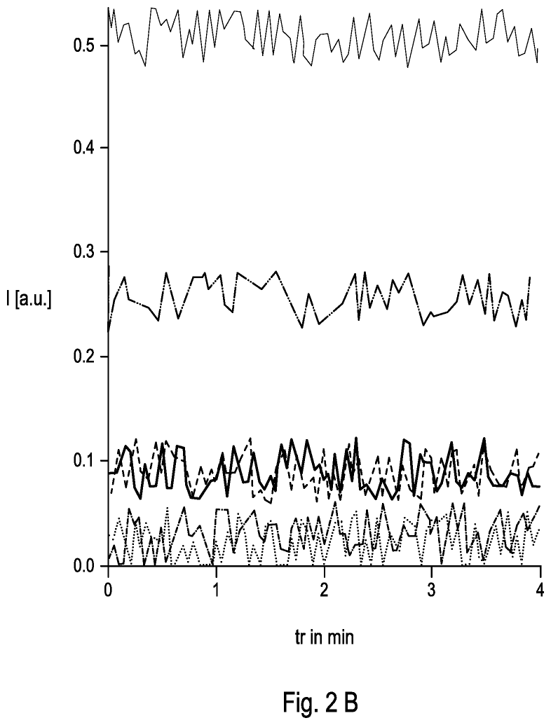

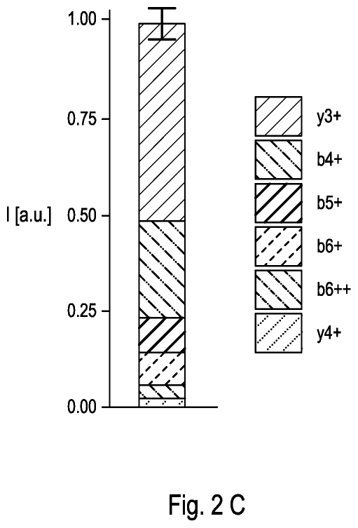

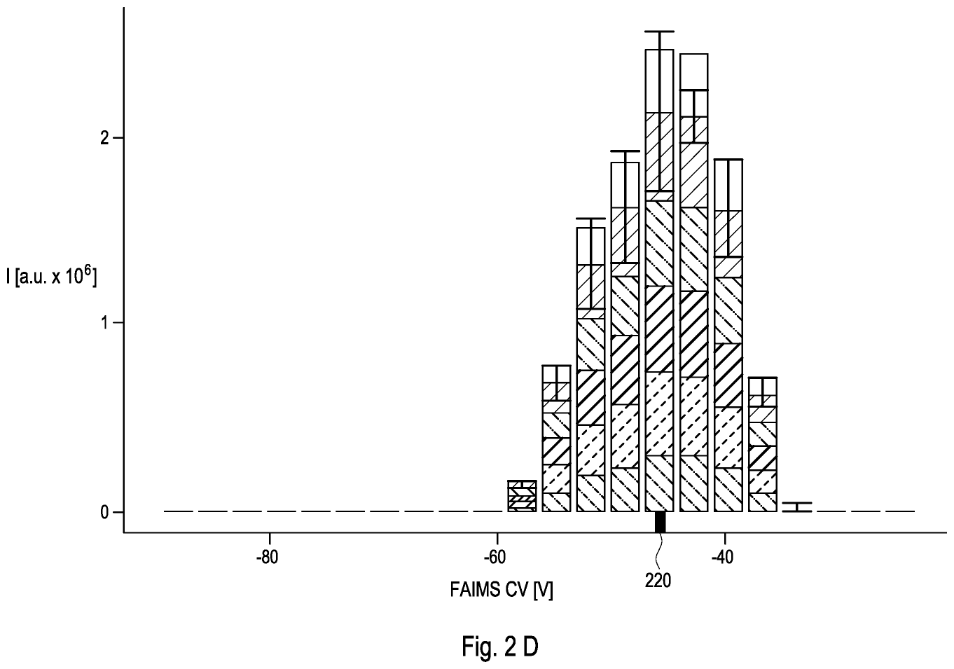

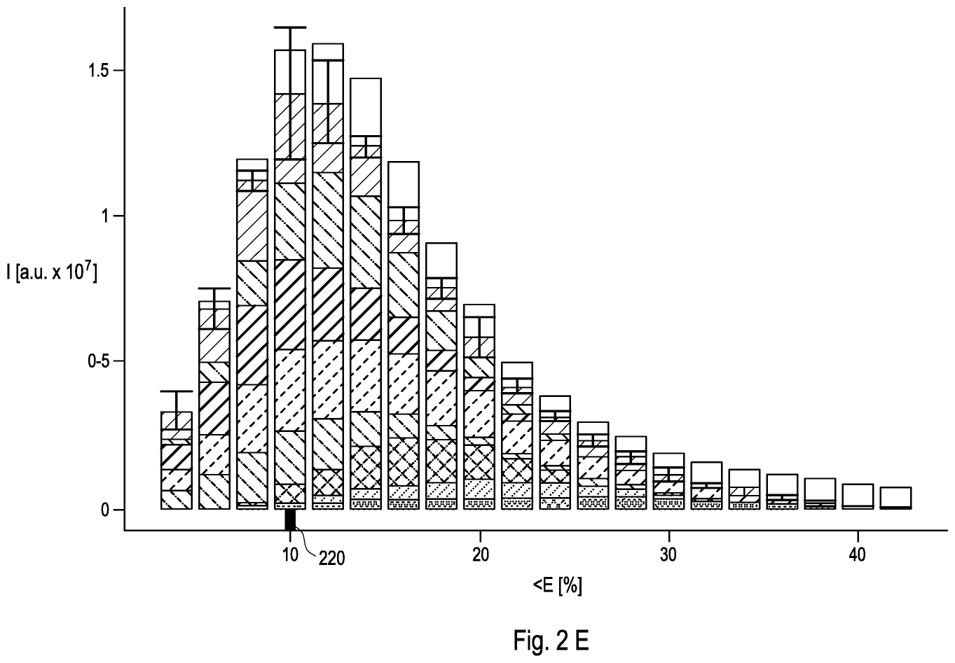

FIGS. 2A to 2E show various embodiments of data analysis and visualization. The embodiments according to FIGS. 2A to 2C correspond to “handmade” schematic illustrations with the purpose of illustrating the concept. The embodiments according to FIGS. 2A to 2C do not correspond to measured data. The embodiments according to FIGS. 2D and 2E are experimental results and correspond to measured data.

To fully harness the power of analyzing peptides in batches, using the static spray approach, programs to extract, analyze and visualize results of optimizations were developed.

Advantageously, the programs are tailored to the applications described within the application and can therefore produce results from an instrument output without a requirement for further user input. With other software, manual refining is typically required peptide-by-peptide.

In FIG. 2A, mass spectra are illustrated resulting from a liquid column separation. An intensity I in arbitrary units is illustrated in dependency of a retention time tₜ in min. Whenever parameters are adapted for optimization, the signal may additionally shift due to progression on the time axis. In FIG. 2B, mass spectra are illustrated resulting from a static spray approach. An intensity I in arbitrary units is illustrated in dependency of a retention time tᵣ in min. It can be seen that, with static spray (ss), signal is ideally constant, affected only by noise and instrument parameters. In FIG. 2C, it is illustrated that the ss signal can further be condensed to reflect what is relevant for the workflow. The different textures reflect the different characteristic signals/transitions/fragments produced by collisional dissociation of targeted precursor/analyte/species.

In FIGS. 2D and 2E, it is illustrated that, when cycling through instrument parameters like FAIMS CV (FIG. 2D) or Collision Energy CE, the visualization allows to clearly identify optimal parameter values and indicated with mark 220.

The data extraction closely resembles what is typically done with the Skyline software (https://skyline.ms) and other software in the field the developed program calculates ions produced in fragmentation of each analyte peptide and facilitates data extraction with a strong focus on LC-MS, visualizing data as ion chromatograms (FIG. 2A). It is also capable of extracting the data as produced but with some added friction and manual input required. Overall, the workflow may be common but most software these days strongly expect LC separation.

Once instrument parameters are cycled for optimization in static spray, one may further be limited by the software used, and whether it supports readout of the parameters. While most software is not set up for this recently, software has also been released elsewhere to facilitate this via R scripting: https://github.com/fgcz/rawDiag#343--how-to-get-all-scan-attributes-assosiated-to-each-scan.

For data analysis and visualization, the results as shown in FIGS. 2D and 2E may be visualized. For most parameters, the identification of the optimum may be straight forward according to these plots. For optimization of collision energy (FIG. 2E) there may be further nuance, due to the collision energy parameter not only affecting an overall signal intensity, but also a signal composition. In the example, some ions only appear at high energy.

The data gathered in our automated approach may be used to probe some interesting scientific questions about what a best collision energy would be for various applications.

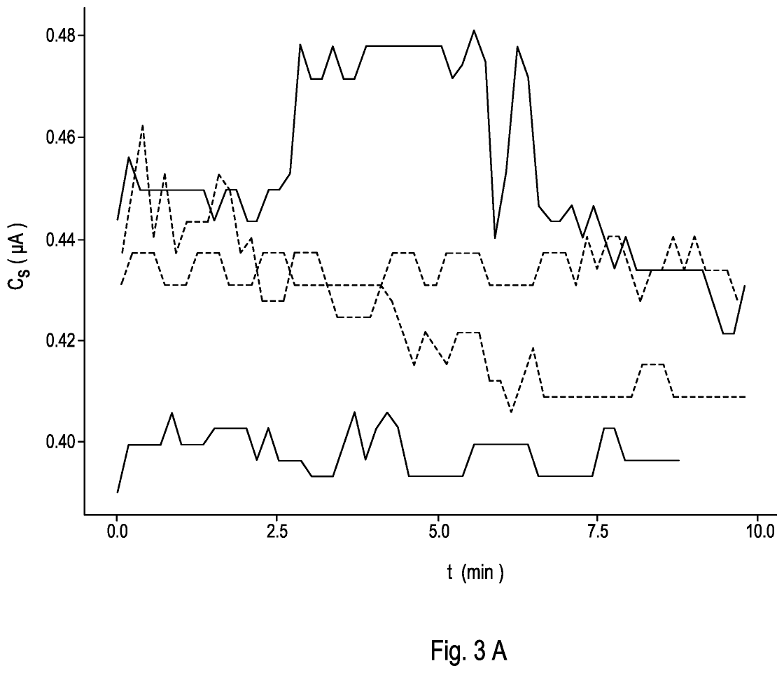

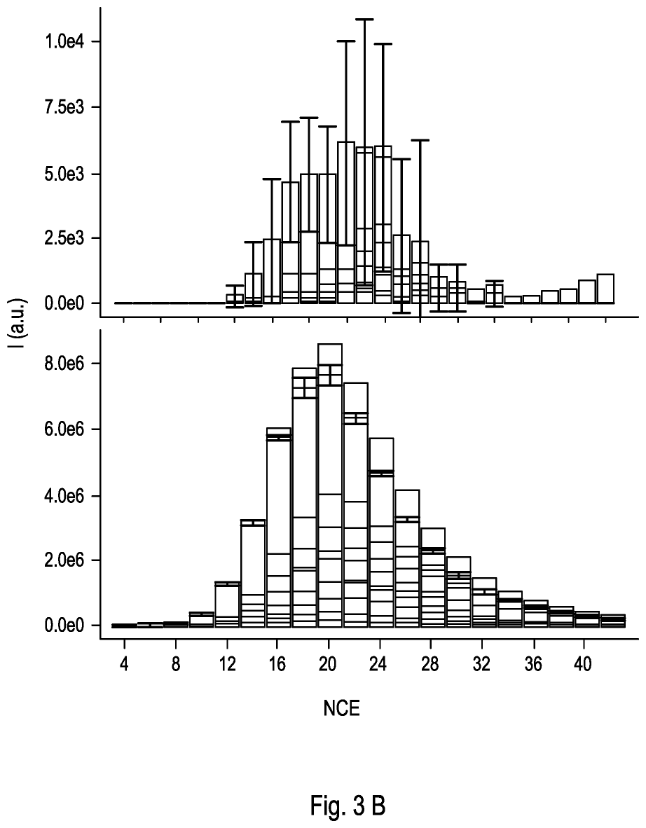

FIGS. 3A and 3B show a stability of a spray current cₛ in different static spray settings (FIG. 3A) and the corresponding quality of MS data (FIG. 3B).

FIG. 3A shows the spray current cₛ in different static spray settings in dependency of the time t in min. The data marked with circles corresponds to data from a static spray setup with a coated emitter. The data marked with crosses corresponds to data from a static spray setup with a liquid junction and an uncoated emitter. The data with crosses is acquired with a mass spectrometer system according to the present invention. In FIG. 3A it can be seen that the spray current is more stable with uncoated emitter in the presence of the liquid junction compared to the coated glass capillary which corresponds to a classical static spray approach.

In FIG. 3B, the intensity I in a.u. is illustrated in dependency of the normalized collision energy NCE. It is demonstrated that identifying clear optimum values for collision energy is less efficient with a coated emitter (see upper panel) compared to an uncoated capillary (see lower panel) in the presence of a liquid junction.

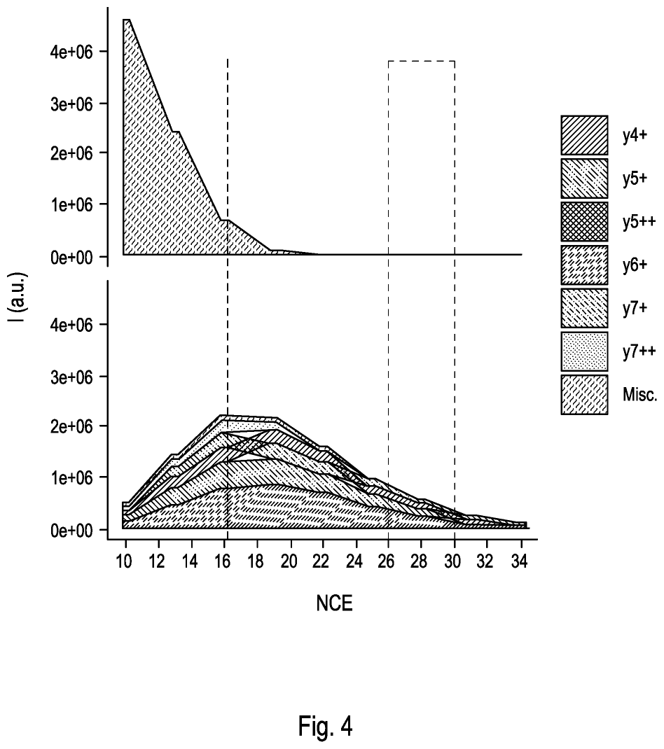

FIG. 4 shows an optimization of the normalized collision energy NCE. An intensity I in a.u. is illustrated in dependency of the normalized collision energy NCE. In the upper panel the intact peptide is reflected. In the lower panel the different fragments y4+, y5+, y5++, y6+, y7+, y7++ are shown. An HLA-I associated 9-mer peptide (2+) shows an optimum NCE value (dotted line) lower than the default values routinely used in peptidomics (26-30%, the band with dotted lines). Optimized NCE will allow higher sensitivity of peptide detection in biological samples.

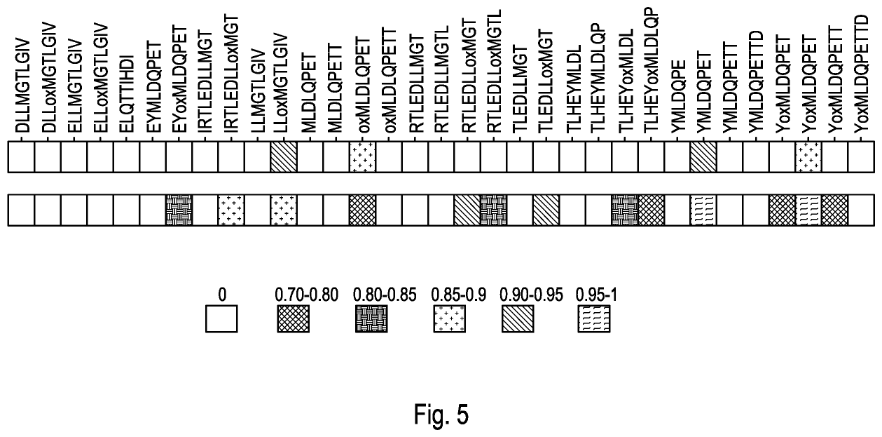

FIG. 5 shows cell plots showing effects of Field Asymmetric Ion Mobility Spectrometry (FAIMS) parameter optimization on the sensitivity of peptide detection, specifically of HPV-derived HLA-A2 restricted target peptides. The upper panel refers to data without FAIMS and the lower panel refers to data with FAIMS. FAIMS interface cannot be used in targeted MS without prior optimization of compensation voltage (CV) for each target peptide. Higher sensitivity for peptide detection in the presence of FAIMS (analysis based on optimized CV for each peptide) is clearly shown. The code of the cell plot is according to the dot product (dotp, varying between 0-1) corresponding to the normalized spectral contrast angle. The dotp is scoring the similarity of the detected peptide fragmentation pattern as compared to an external library (reference spectra generated with synthetic peptides).

### LIST OF REFERENCE NUMBERS

110 mass spectrometer system
112 automated system
114 mass spectrometric analyzer
116 ion source
118 ionization chamber
120 emitter end
122 electrospray emitter
124 emitter tip
126 fluid entrance end
128 fused silica capillary
130 holder
132 autosampler
134 autosampler outlet
136 sample
138 pipe
140 fused silica capillary
142 pipe fluid outlet end
144 pipe fluid inlet end
146 liquid junction
148 connecting element
149 voltage source
150 hollow cylinder
152 first end
154 second end
156 screw
158 through hole
160 nano-gap
162 sample tray
164 flask
166 first valve
168 sample loop
170 stationary element
172 rotatable element
174 channel
176 ports
178 fluid loading device
180 syringe
182 pump
184 nano-pump
186 sample port
188 fluid loading device port
190 pump port
192 outlet port
194 inlet port
196 second valve
198 waste container
200 rotatable element
202 channel
204 port
206 third valve
208 washing solvent container
210 arrow
212 arrow
214 arrow
216 interior volume
218 arrow
220 mark
222 waste container
224 needle
226 needle seat

1. An automated system for providing at least one sample for electrospray ionization in a mass spectrometer system, wherein the automated system comprises:
at least one electrospray emitter comprising at least one emitter end having at least one emitter tip and at least one fluid-entrance end;
at least one autosampler, wherein the autosampler comprises at least one autosampler outlet, wherein the autosampler is configured for providing at least one sample having at least one analyte;
at least one pipe having at least one pipe fluid-outlet end and at least one pipe fluid-inlet end, wherein the pipe fluid-inlet end is fluidically connected to the autosampler outlet;
at least one liquid junction, wherein the liquid junction comprises at least one connecting element being made of at least one electrically conductive material, wherein the connecting element receives the fluid-entrance end of the electrospray emitter and the pipe fluid-outlet end of the pipe such that a fluid connection between the electrospray emitter and the pipe is established, wherein the connecting element is electrically connectable to at least one voltage source;
wherein the emitter tip comprises an opening having a diameter of 1 μm to 10 μm.

2. The automated system according to claim 1, wherein the opening of the emitter tip has a diameter of 3 μm to 5 μm.

3. The automated system according to claim 1, wherein the pipe fluid-inlet end of the pipe is directly fluidically connected to the autosampler outlet.

4. The automated system according to claim 1, wherein the fluid-entrance end of the electrospray emitter and the pipe fluid-outlet end of the pipe are received in the connecting element such that a nano-gap is formed between the fluid-entrance end and the pipe fluid-outlet end.

5. The automated system according to claim 1, wherein the connecting element comprises at least one hollow cylinder having at least one first end and at least one opposing second end, wherein the fluid-entrance end of the electrospray emitter is received in the first end and wherein the pipe fluid-outlet end is received in the second end.

6. The automated system according to claim 1, wherein the autosampler further comprises:
at least one sample tray which is configured for providing the at least one sample;
at least one first valve having at least one sample loop being configured for receiving the sample;
at least one fluid loading device, wherein the fluid loading device is configured for loading the sample loop of the first valve with the sample provided by the sample tray; and
at least one pump, wherein the pump is configured for transferring the sample from the sample loop of the first valve to the autosampler outlet and into the electrospray emitter.

7. The automated system according to claim 6, wherein the autosampler comprises at least one second valve, wherein the second valve is configured for electively fluidically connecting an outlet port of the first valve to the autosampler outlet or to at least one waste container.

8. The automated system according to claim 7, wherein the second valve is configured to revert a pump outlet of the first valve to the waste container, as soon as the sample is transferred from the sample loop of the first valve into the pipe fluid-inlet end of the pipe.

9. A mass spectrometer system, wherein the mass spectrometer system comprises at least one automated system according to claim 1, wherein the mass spectrometer system further comprises at least one mass spectrometric analyzer having at least one ion source, wherein the emitter end of the electrospray emitter is arranged within the ion source.

10. A method for providing and ionizing at least one sample by electrospray ionization in a mass spectrometer system, wherein the method comprises using the automated system according to claim 1, wherein the method comprises the following steps:
a) providing at least one sample in at least one sample tray of the autosampler;
b) transferring the sample from the sample tray to the autosampler outlet, whereby the sample is further transferred into the electrospray emitter via the pipe and the liquid junction; and
c) electrically charging at least one component of the sample by applying an electrical voltage to the connecting element of the liquid junction via the voltage source.

11. The method of claim 10, wherein the pressure within the electrospray emitter during electrospray ionization is ambient pressure or wherein the pressure within the electrospray emitter during electrospray ionization is from 5 bar to 15 bar.

12. A method for optimizing at least one mass spectrometry (MS) parameter comprising
(A) providing and ionizing at least one sample by electrospray ionization;
(B) recording at least two MS spectra under conditions comprising at least two different values for said at least one MS parameter;
(C) comparing the MS spectra recorded in step (b), and
(D) thereby, based on the comparison in step (C), optimizing said at least one MS parameter.

13. A method for detecting at least one analyte in a sample by mass spectrometry (MS), the method comprising:
(A) providing and ionizing a sample using the automated system according to the method for providing and ionizing at least one sample of claim 10; and
(B) recording at least one MS spectrum of the ionized sample of step (A).

14-15. (canceled)
